(19) United States
(12) Patent Application Publication
(10) Pub. No.: US 2007/0009831 A1
(43) Pub. Date: Jan. 11, 2007

(54) PLANOGRAPHIC PRINTING PLATE MATERIAL AND IMAGE FORMATION METHOD

(75) Inventor: Yasuhiko TAKAMUKI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/427,468

(22) Filed: Jun. 29, 2006

(30) Foreign Application Priority Data
Jul. 11, 2005 (JP) JP2005-201387

(51) Int. Cl. G03C 1/00

(52) U.S. Cl. 430/270.1

(57) ABSTRACT

Disclosed is a planographic printing plate material comprising an aluminum support and provided thereon, a light sensitive layer containing an acid-generating agent composition generating an acid on violet laser beam exposure, a cationically polymerizable monomer which polymerizes by action of an acid, and an alkali-soluble polymeric binder, wherein the light sensitive layer is an outermost layer.

This application is based on Japanese Patent Application No. 2005-201387, filed on Jul. 11, 2005 in Japanese Patent Office, the entire content of which is hereby incorporated by reference.

### FIELD OF THE INVENTION

The present invention relates to a planographic printing plate material used in a computer-to-plate (CTP) system, and image formation method employing the printing plate material.

### BACKGROUND OF THE INVENTION

In recent years, a CTP system has been developed and put into practical use, which directly writes digital image data on a light sensitive planographic printing plate material employing laser light in a process of manufacturing a printing plate for off-set printing.

In a printing field in which relatively high printing durability is required, a negative working planographic printing plate material is known which comprises a polymerizable light sensitive layer containing a polymerizable compound. Further, a CTP system has been put into practical use, which employs inexpensive violet laser as a light source which reduces running cost, and enables exposure under a yellow lamp, i.e., safelight (see for example, Japanese Patent O.P.I. Publication No. 2000-35673.).

The above negative working planographic printing plate material employs a light sensitive layer containing a radical polymerization composition and requires an oxygen shielding layer (forming an outermost layer) on the light sensitive layer. This planographic printing plate material increases cost of manufacture and requires an extra step, i.e., a pre-washing step removing the oxygen shielding layer on development, which increases running cost. In view of the above, a printing plate material which is free from an extra layer such as the oxygen shielding layer) has been desired.

Image formation materials are known which comprises an outermost light sensitive layer containing a compound generating an acid by action of actinic rays and a compound which polymerizes by action by an acid as disclosed in for example, Japanese Patent O.P.I. Publication Nos. 7-128850 and 2002-207293, and Japanese Patent Examined Publication No. 7-103171. In these patent documents, there is description which cures the light sensitive layer by ultraviolet rays or converts light to heat by action of infrared or near-infrared laser, however, there is no description forming an image employing violet laser.

Further, the image formation materials described above have problems in that sensitivity is insufficient and storage stability at high humidity condition is poor, which lowers reproducibility at highlight portions after storage at high humidity condition. Accordingly, a planographic printing plate material for CTP system comprising an outermost light sensitive layer has been desired which provides high sensitivity, excellent storage stability at high humidity, and excellent reproducibility at highlight portions after stored at high humidity.

### SUMMARY OF THE INVENTION

The present invention has been made in view of the above. An object of the invention is to provide a planographic printing plate material comprising an outermost light sensitive layer which gives high sensitivity, excellent storage stability at high humidity, and excellent reproducibility at highlight portions after stored at high humidity, and to provide an image formation method employing the planographic printing plate material.

### DETAILED DESCRIPTION OF THE INVENTION

The above object has been attained by one of the following constitutions:

1. A planographic printing plate material comprising an aluminum support and provided thereon, a light sensitive layer containing an acid-generating agent composition generating an acid on violet laser beam exposure, a cationically polymerizable monomer which polymerizes by action of an acid, and an alkali-soluble polymeric binder, wherein the light sensitive layer is an outermost layer.

2. The planographic printing plate material of item 1 above, wherein the acid-generating agent composition is comprised of the acid-generating agent and a dye having absorption maximum in the wavelength regions of from 350 to 440 nm.

3. The planographic printing plate material of item 2 above, wherein the acid-generating agent is an iron-arene complex.

4. The planographic printing plate material of item 2 above, wherein the acid-generating agent is a halogen-containing compound represented by the following formula (1),
R¹—C(Y)₂—(C═O)—R² Formula (1)
wherein R¹ represents a hydrogen atom, a halogen atom, an alkyl group, an aryl group, an acyl group, an alkylsulfonyl group, an arylsulfonyl group, or a cyano group; R² represents a monovalent substituent, provided that R¹ and R² may combine with each other to form a ring; and Y represents a halogen atom.

5. The planographic printing plate material of item 4 above, wherein the halogen-containing compound represented by formula (1) is a halogen-containing compound represented by the following formula (1′),
C(Y)₃—(C═O)—X—R³ Formula (1′)
wherein R³ represents a monovalent substituent, X represents —O— or —NR⁴— in which R⁴ represents a hydrogen atom or an alkyl group, provided that when X represents —NR⁴—, R³ and R⁴ may combine with each other to form a ring; and Y represents a halogen atom.

6. The planographic printing plate material of item 2 above, wherein the dye is represented by the following formula (2), 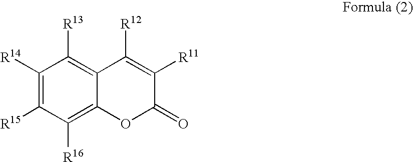
wherein R¹¹, R¹², R₁₃, R¹⁴, R¹⁵ and R¹⁶ independently represent a hydrogen atom, an alkyl group, a cycloalkyl group, an alkenyl group, an alkinyl group, an aryl group, a heteroaryl group, a heterocyclic group, an alkoxy group, a cycloalkoxy group, an aryloxy group, an alkylthio group, a cycloalkylthio group, an arylthio group, an alkoxycarbonyl group, an aryloxycarbonyl group, a sulfamoyl group, an acyl group, an acyloxy group, an amido group, a carbamoyl group, a ureido group, a sulfinyl group, an alkylsulfonyl group, an amino group, a halogen atom, a cyano group, a nitro group or a hydroxyl group, provided that any adjacent two of R¹¹, R¹², R¹³, R¹⁴, R¹⁵ and R¹⁶ may combine with each other to form a ring.

7. The planographic printing plate material of item 2 above, wherein the dye is represented by the following formula (3), 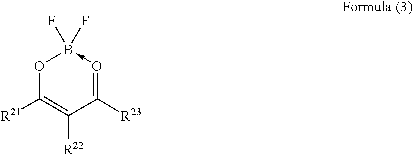
wherein R²¹, R²² and R²³ independently represent a hydrogen atom or a substituent, provided that R²¹ and R²² may combine with each other to form a ring or R²² and R²³ may combine with each other to form a ring.

8. The planographic printing plate material of item 2 above, wherein the dye is represented by the following formula (4), 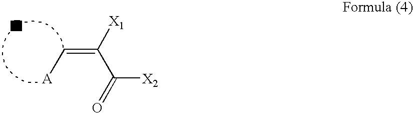
wherein A represents a sulfur atom or —NR₁— in which R₁ represents a substituted or unsubstituted alkyl group or a substituted or unsubstituted aryl group; Z represents a non-metallic atomic group necessary to form a basic nucleus together with A; and X₁ and X₂ independently represent a monovalent substituent, provided that X₁ and X₂ may combine with each other to form an acidic nucleus.

9. The planographic printing plate material of item 2 above, wherein the dye is represented by the following formula (5), 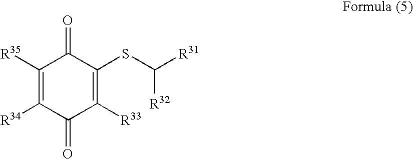
wherein R³¹ represents an alkyl group, an aryl group, an alkenyl group, a cycloalkyl group, an aralkyl group or a heterocyclic group; R³² represents a hydrogen atom, an alkyl group, an aryl group, an alkenyl group, a cycloalkyl group, an aralkyl group or a heterocyclic group, provided that R³¹ and R³² may combine with each other to form a ring; and R³³, R³⁴ and R³⁵ independently represent a hydrogen atom, an alkyl group, an alkoxy group, an aryloxy group, an alkylthio group, an arylthio group, a dialkylamino group or a diarylamino group.

10. The planographic printing plate material of item 1 above, wherein the light sensitive layer contains, as the cationically polymerizable monomer, an epoxy compound, a vinyl ether compound or an oxetane compound.

11. The planographic printing plate material of item 1 above, wherein the light sensitive layer contains, as the cationically polymerizable monomer, an oxetane compound and at least one of an epoxy compound and a vinyl ether compound.

12. The planographic printing plate material of item 2 above, wherein the light sensitive layer contains 0.1 to 20% by weight of the dye, 20 to 80% by weight of the cationically polymerizable monomer and 15 to 70% by weight of the alkali-soluble polymeric binder, each based on the total weight of light sensitive layer, and 0.1 to 20% by weight of the acid-generating agent based on the weight content of the cationically polymerizable monomer.

13. An image formation method comprising the steps of (a) imagewise exposing the light sensitive layer of the planographic printing plate material of any one of items 1 through 12 above, employing violet laser beam, and (b) removing the light sensitive layer at unexposed portions employing an alkaline developer.

The preferred embodiment of the invention will be detailed below, but the invention is not limited thereto. (Cationically polymerizable monomer which polymerizes by action of an acid)

As the cationically polymerizable monomer which polymerizes by action of an acid (hereinafter also referred to simply as cationically polymerizable compound), there are, for example, an epoxy compound, a vinyl ether compound or an oxetane compound disclosed in Japanese Patent O.P.I. Publication Nos. 6-9714, 2001-31892, 2001-40068, 2001-55507, 2001-310938, 2001-310937, and 2001-220526. As the epoxy compound, there are an aromatic epoxide, an alicyclic epoxide and an aliphatic epoxide.

The aromatic epoxide is preferably a di- or poly-glycidyl ether manufactured by a reaction of polyhydric phenol having at least one aromatic ring or of an alkylene oxide adduct thereof with epichlorohydrin, and examples thereof include, for example, such as di- or poly-glycidyl ether of bisphenol A or of an alkylene oxide adduct thereof, di- or poly-glycidyl ether of hydrogenated bisphenol A or of an alkylene oxide adduct thereof and novolac type epoxy resin. Herein, alkylene oxide includes such as ethylene oxide and propylene oxide.

The alicyclic epoxide is preferably a compound containing cyclohexene oxide or cyclopentene oxide obtained by epoxydizing a compound having at least one cycloalkane ring such as cyclohexene or cyclopentene by use of a suitable oxidizing agent such as hydrogen peroxide or a peracid.

The aliphatic epoxide is preferably a di- or polyglycidyl ether of aliphatic polyhydric alcohol or of an alkylene oxide adduct thereof; the typical examples thereof include diglycidyl ether of alkylene glycol, such as diglycidyl ether of ethylene glycol, diglycidyl ether of propylene glycol and diglycidyl ether of 1,6-hexane diol; polyglycidyl ether of polyhydric alcohol such as di- or triglycidyl ether of glycerin or of an alkylene oxide adduct thereof; and diglycidyl ether of polyalkylene glycol such as diglycidyl ether of polyethylene glycol or of an alkylene oxide adduct thereof and diglycidyl ether of polypropylene glycol or of an alkylene oxide adduct thereof. Herein, alkylene oxide includes such as ethylene oxide and propylene oxide.

Among these epoxides, the aromatic epoxide and alicyclic epoxide are preferable and the alicyclic epoxide is specifically preferable, in view of high sensitivity. In the invention, one kind of epoxides described above alone may be utilized, and suitable combinations of two or more kinds thereof may also be utilized.

Examples of the vinyl ether compound include di- or tri-vinyl ether compounds such as ethylene glycol divinyl ether, diethylene glycol divinyl ether, triethylene glycol divinyl ether, propylene glycol divinyl ether, dipropylene glycol divinyl ether, butane diol divinyl ether, hexane diol divinyl ether, cyclohexane dimethanol divinyl ether, and trimethylol propane trivinyl ether; and mono vinyl ether compounds such as ethyl vinyl ether, n-butyl vinyl ether, iso-butyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether-o-propylene carbonate, dodecyl vinyl ether, diethylene glycol monovinyl ether and octadecyl vinyl ether.

In these vinyl ether compounds, when reproducibility at highlight portions is considered, di- or tri-vinyl ether compounds are preferable, and particularly divinyl ether compounds are preferable. In the present invention, these vinyl ether compounds may be used alone or as an admixture of two or more kinds thereof.

The oxetane compound refers to a compound having an oxetane ring, and well-known oxetane compounds as disclosed in Japanese Patent O.P.I. Publication Nos. 2001-220526 and 2001-310937 cab be used in the invention.

The oxetane compound used in the invention is preferably an oxetane compound having 1 to 4 oxetane rings. An oxetane compound, which has not less than 5 oxetane rings, provides a light sensitive composition with insufficient highlight reproducibility.

As an oxetane compound having one oxetane ring, an oxetane compound is cited which is represented by the following formula (101),

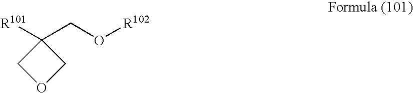

In formula (101), R¹⁰¹ represents a hydrogen atom, an alkyl group having from 1 to 6 carbon atoms such as a methyl group, an ethyl group, a propyl group, a butyl group, etc.; a fluoroalkyl group having from 1 to 6 carbon atoms; an allyl group; an aryl group; a furyl group; or a thienyl group; and R¹⁰² represents an alkyl group having from 1 to 6 carbon atoms such as a methyl group, an ethyl group, a propyl group, a butyl group, etc.; an alkenyl group having from 2 to 6 carbon atoms such as a 1-propenyl group, a 2-propenyl group, a 2-methyl-1-propenyl group, a 2-methyl-2-propenyl group, a 1-butenyl group, a 2-butenyl group, a 3-butenyl group, etc.), an aromatic ring-containing group such as a phenyl group, a benzyl group, a fluorobenzyl group, a methoxybenzyl group; a phenoxyethyl group, etc.; an alkylcarbonyl group having from 2 to 6 carbon atoms such as an ethylcarbonyl group, a propylcarbonyl group, a butylcarbonyl group, etc.; an alkoxycarbonyl group having from 2 to 6 carbon carbons such as an ethoxycarbonyl group, a propoxycarbonyl group, a butoxycarbonyl group, etc.; an N-alkylcarbamoyl group having from 2 to 6 carbon atoms such as an ethylcarbamoyl group, a propylcarbamoyl group, a butylcarbamoyl group, a pentylcarbamoyl, etc. The oxetane compound used in the invention is preferably a compound having one oxetane ring in that the composition containing such a compound is excellent in tackiness, low in viscosity, and is easy to handle.

As an oxetane compound having two oxetane rings, an oxetane compound is cited which is represented by the following formula (102),

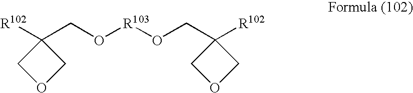

In formula (102), R¹ is the same as those denoted in R¹⁰¹ in formula (101); and R¹⁰³ represents a straight chained or branched alkylene group such as an ethylene group, a propylene group, a butylene group, etc.; a straight chained or branched polyalkyleneoxy group such as a poly(ethyleneoxy) group, a poly(propyleneoxy group, etc.; a straight chained or branched unsaturated divalent hydrocarbon group such a propenylene group, a methylpropenylene group, a butenylene group, etc.; an alkylene group containing a carbonyl group; an alkylene group containing a carbonyloxy group; or an alkylene group containing a carbamoyl group. R¹⁰³ also represents a divalent group selected from groups represented by the following formulae (103), (104), and (106),

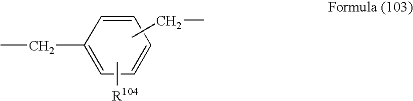

In formula (103), R¹⁰⁴ represents a hydrogen atom, an alkyl group having from 1 to 4 carbon atoms such as a methyl group, an ethyl group, a propyl group, a butyl group, etc.; an alkoxy group having from 1 to 4 carbon atoms such as a methoxy group, an ethoxy group, a propoxy group, a butoxy group, etc.; a halogen atom such as a chlorine atom, a bromine atom, etc.; a nitro group; a cyano group; a mercapto group; a lower alkylcarboxy group; carboxyl group; or a carbamoyl group.

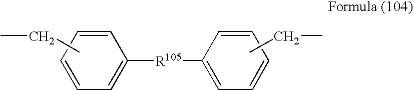

In formula (104), R¹⁰⁵ represents an oxygen atom, a sulfur atom, a methylene group, —NH—, —SO—, —SO₂—, —(CF₃)₂—, or —C(CH₃)₂—.

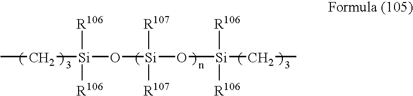

In formula (105), R¹⁰⁶ represents an alkyl group having from 1 to 4 carbon atoms such as a methyl group, an ethyl group, a propyl group, a butyl group, etc., or an aryl group; “n” represents an integer of from 0 to 2000; and R¹⁰⁷ represents an alkyl group having from 1 to 4 carbon atoms such as a methyl group, an ethyl group, a propyl group, a butyl group, etc, or an aryl group, or a group represented by the following formula (106),

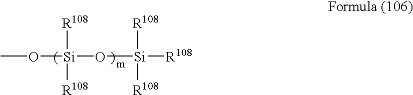

In formula (106), R¹⁰⁸ represents an alkyl group having from 1 to 4 carbon atoms such as a methyl group, an ethyl group, a propyl group, a butyl group, etc., or an aryl group; and m represents an integer of from 0 to 100.

Examples of a compound having two oxetane rings include the following oxetane compounds 107 and 108.

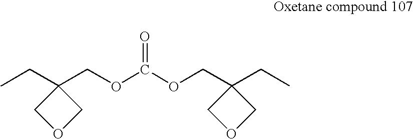

Oxetane compound 107 is a compound in which in formula (102), R¹⁰¹ is an ethyl group, and R¹⁰³ is a carbonyl group.

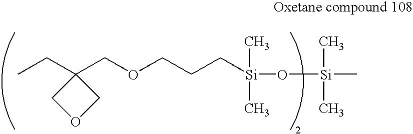

Oxetane compound 108 is a compound in which in formula (102), R¹⁰¹ is an ethyl group, and R³ is a group in which in formula (105), R¹⁰⁶ is a methyl group, R¹⁰⁷ is a methyl group, and n is 1.

As another example of an oxetane compound having two oxetane rings, an oxetane compound is cited which is represented by the following formula (109),

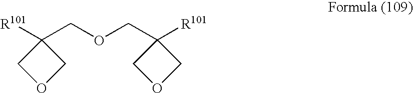

In formula (109), R¹⁰¹ is the same as those denoted in R¹⁰¹ of formula (101).

As a compound having 3 or 4 oxetane rings, there is an oxetane compound represented by the following formula (110).

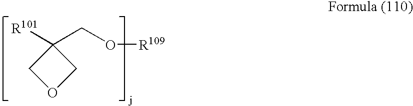

In formula (110), R¹⁰¹ is the same as those denoted in R¹⁰¹ of formula (101) above; R¹⁰⁹ represents a trivalent or tetravalent group represented by formula (111), (112), (113), (114) or (115) below; and j is an integer of 3 or 4.

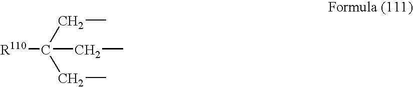

In formula (111), R¹¹⁰ represents a lower alkyl group such as a methyl group, an ethyl group or a propyl group.

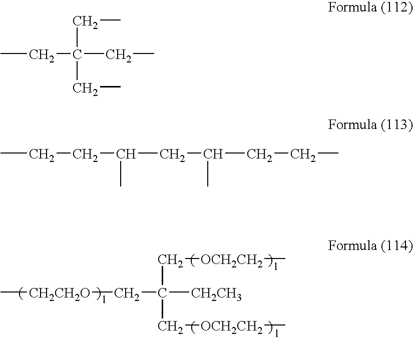

In formula (114), 1 is an integer of from 1 to 10.

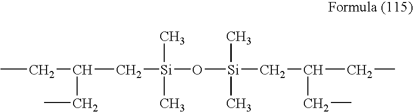

As a typical example of an oxetane compound having 3 or 4 oxetane rings, there is Oxetane compound 116 below.

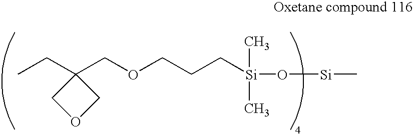

As a typical example of an oxetane compound having 1 to 4 oxetane rings other than the oxetane compounds described above, there is an oxetane compound represented by formula (117) below,

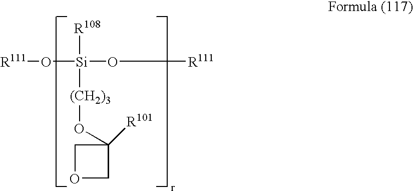

In formula (117), R¹⁰⁸ is the same as those denoted in R¹⁰⁸ of formula (106) above; and R¹¹¹ represents a trialkylsilyl group or an alkyl group having a carbon atom number of from 1 to 4 such as a methyl group, an ethyl group, a propyl group or a butyl group; R¹⁰¹ is the same as those denoted in R¹⁰¹ of formula (101) above; and r is an integer of from 1 to 4.

As preferred examples of oxetane compounds used in the invention, there are oxetane compounds 118, 119 and 120 as shown below.

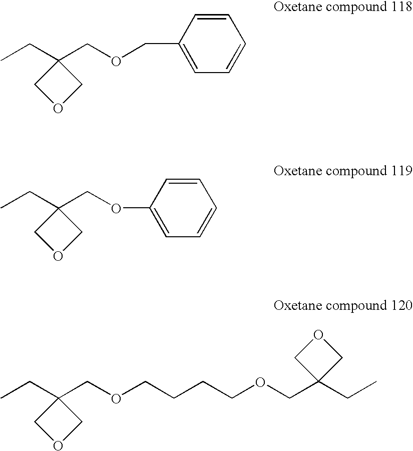

Synthetic methods of the compounds having an oxetane ring described above are not specifically limited, and are carried out according to well-known methods, for example, a method disclosed in B. D. Pattison, J. Am. Chem. Soc., 3455, 79 (1957), which synthesizes oxetane rings from diols.

Besides the oxetane compounds described above, a high molecular oxetane compound having 1 to 4 oxetane rings and having a molecular weight of from 1000 to 5000 can be used as the oxetane compound in the invention. Examples thereof include oxetane compounds 121, 122 and 123 as shown below. 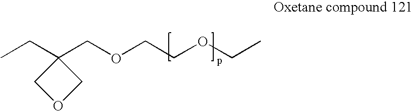
wherein p is an integer of from 20 to 200. 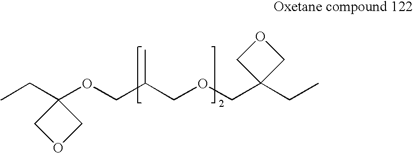
wherein q is an integer of from 15 to 100. 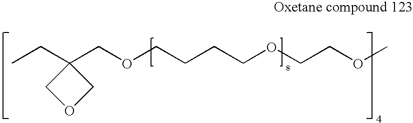
wherein s is an integer of from 20 to 200.

It is preferred that the light sensitive layer in the invention contains, as the cationically polymerizable monomer, at least one oxetane compound and at least one of the epoxy compound and the vinyl ether compound.

The cationically polymerizable monomer content of the light sensitive layer is preferably from 20 to 80% by weight, and more preferably from 40 to 70% by weight, based on the total weight of light sensitive layer.

(Acid Generating Agent Composition)

The acid generating agent composition generating an acid on exposure of violet laser beams will be explained below.

As the acid generating agent (hereinafter also referred to as photolytically acid generating agent), for example, compounds used in a chemical amplification type photo resist or in a light cationic polymerization composition are used (see pages 187-192 of “Organic material for imaging”, edited by Organic Electronics Material seminar and published from Bunshin publishing house (1993). Examples suitable for the present invention will be explained below.

Firstly, a B(C₆F₅)₄⁻, PF₆⁻, AsF₆⁻, SbF₆⁻, CF₃SO₃⁻ salt of an aromatic onium compound such as an aromatic diazonium, ammonium, iodonium, sulfonium, or phosphonium compound, can be listed. Onium compounds having a borate ion as a counte anion is preferred in providing high acid generation capability. Examples of the onium compounds used in the invention will be shown below.

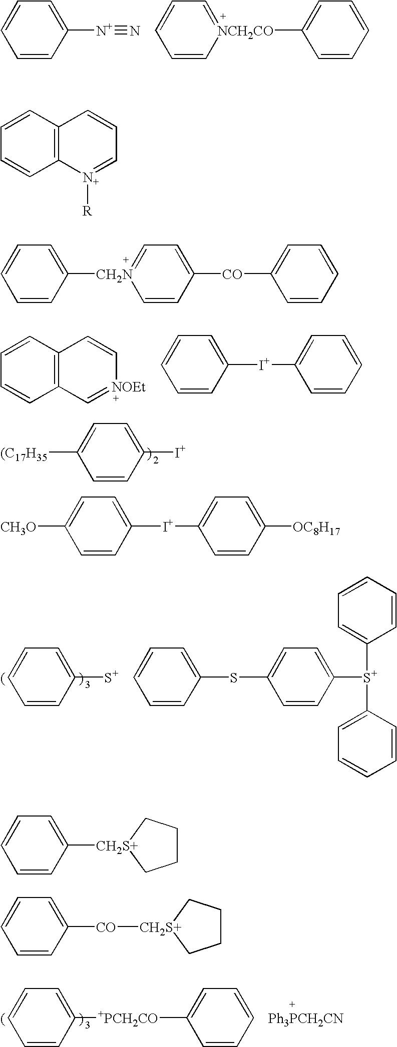

Secondly, sulfone compounds, which generate sulfonic acid, can be listed. Examples thereof will be shown below.

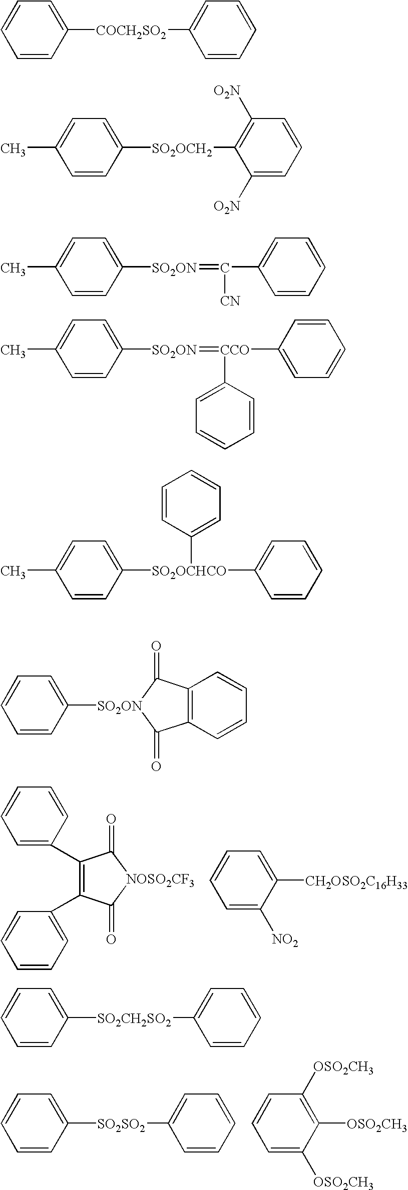

Thirdly, a halogen-containing compound, which generates hydrogen halide, can also be used. In the invention, the halogen-containing compound is preferably used.

In the invention, the halogen-containing compound is preferably used, which is represented by the following formula (1), and a halogen-containing compound is especially preferably used, which is represented by the following formula (1′).
R¹—C(Y)₂—(C═O)—R² Formula (1)
wherein R¹ represents a hydrogen atom, a halogen atom, an alkyl group, an aryl group, an acyl group, an alkylsulfonyl group, an arylsulfonyl group, or a cyano group; R² represents a monovalent substituent, provided that R¹ and R² may combine with each other to form a ring; and Y represents a halogen atom. The monovalent substituent represented by R² represents a substituted or unsubstituted alkyl group, a substituted or unsubstituted aryl group, a substituted or unsubstituted heterocyclic ring group, a substituted or unsubstituted alkoxy group, a substituted or unsubstituted aryloxy group, a substituted or unsubstituted amino group or a hydroxyl group.
C(Y)₃—(C═O)—X—R³ Formula (1′)
wherein R³ represents a monovalent substituent; X represents —O— or —NR⁴— in which R⁴ represents a hydrogen atom or an alkyl group, provided that when X represents —NR⁴—, R³ and R⁴ may combine with each other to form a ring; and Y represents a halogen atom. The monovalent substituent represented by R³ represents a substituted or unsubstituted alkyl group, a substituted or unsubstituted aryl group, or a substituted or unsubstituted heterocyclic ring group.

As examples of the halogen-containing compound represented by formula (1), there are compounds BR1 through BR66 described later. Halogen-containing compound in which bromine atoms in these compounds are replaced by chlorines are suitably used in the invention.

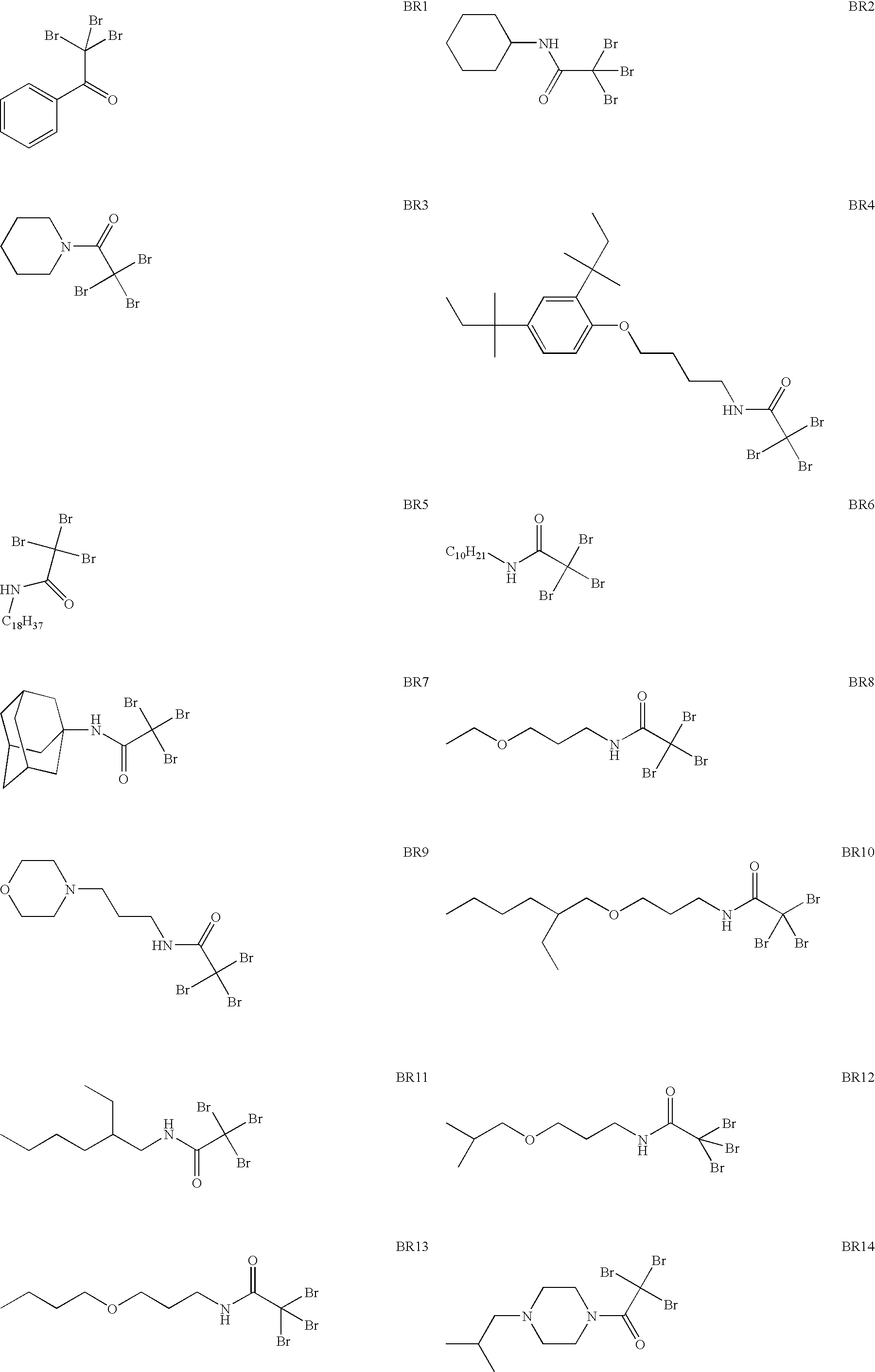

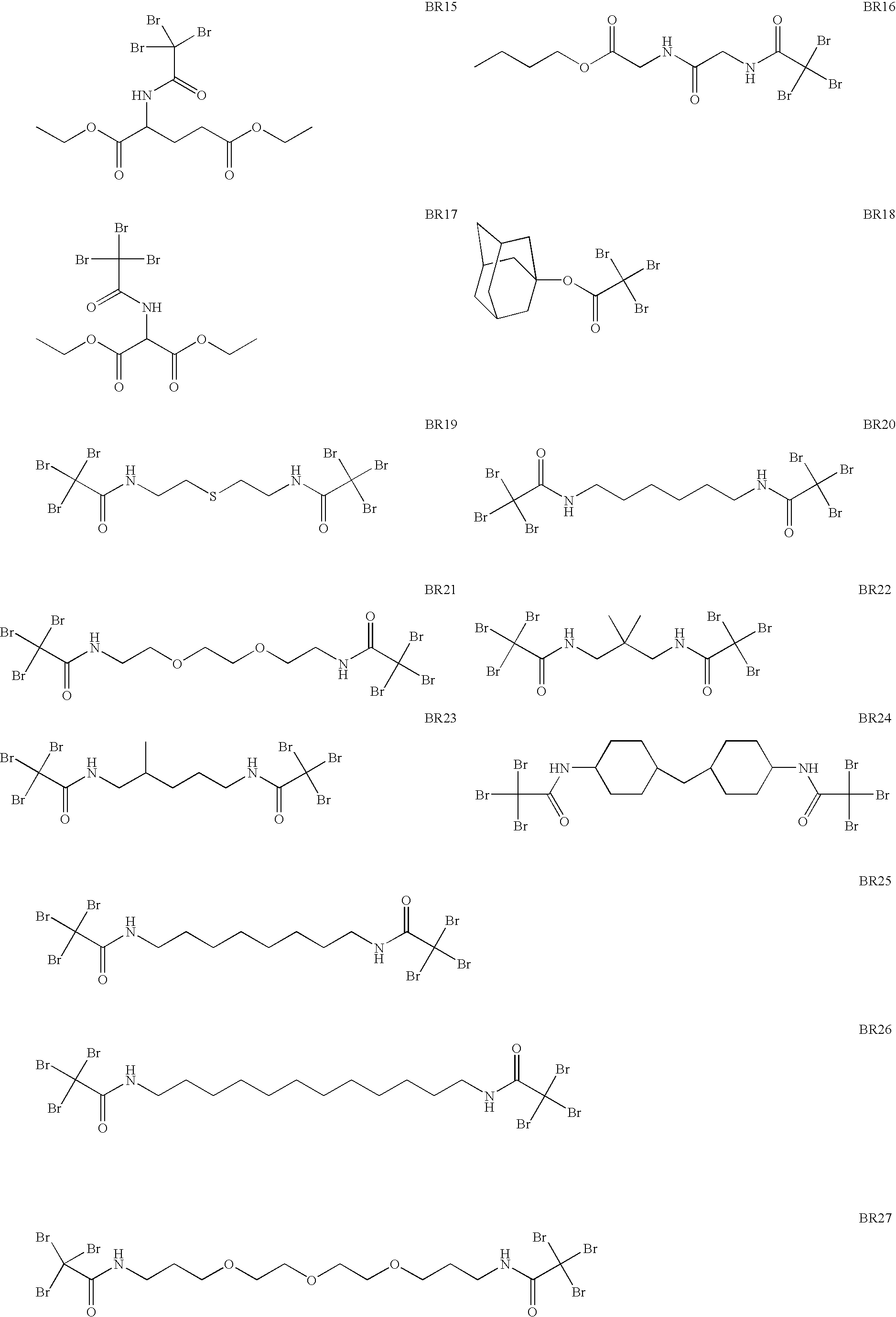

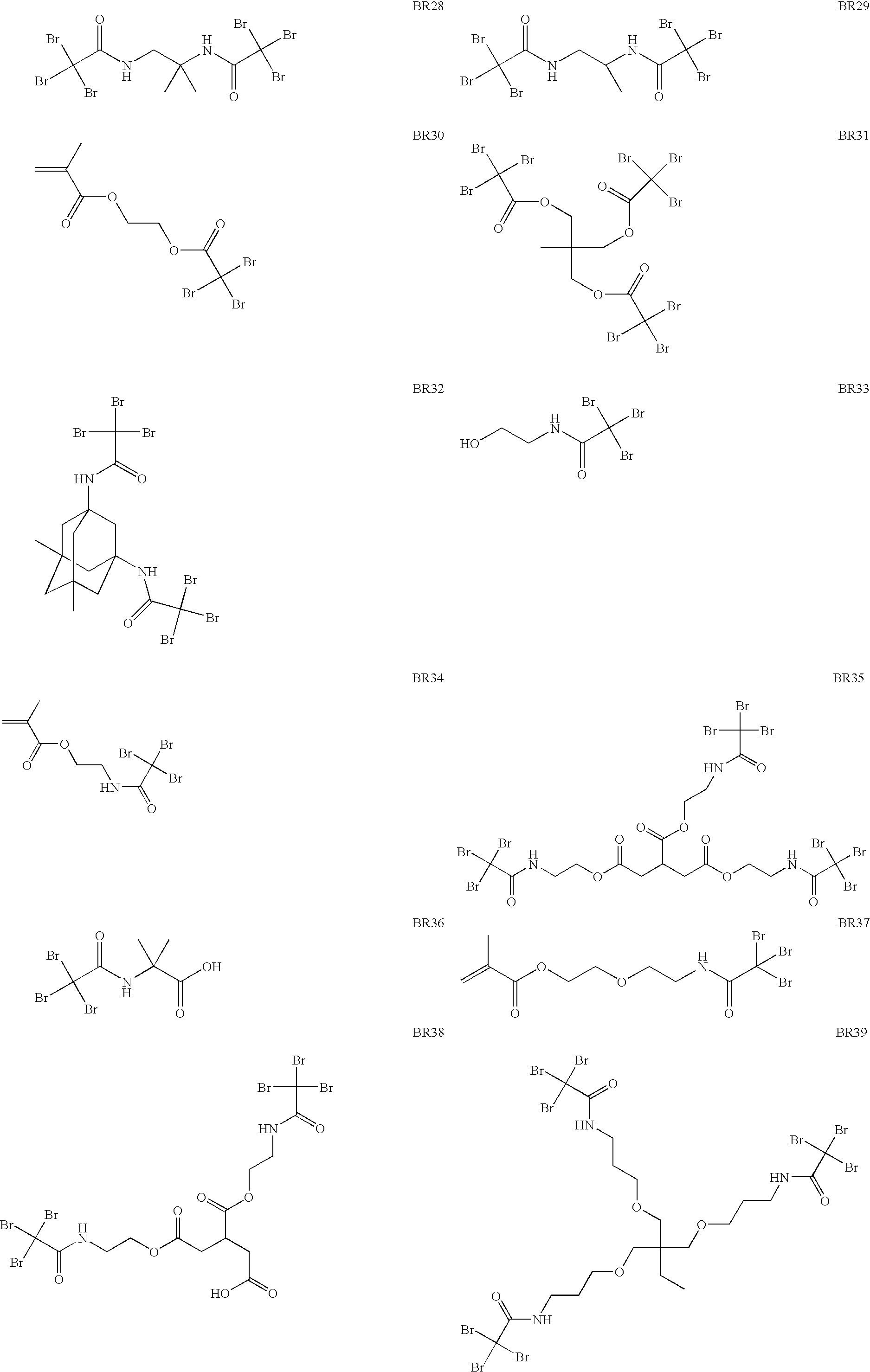

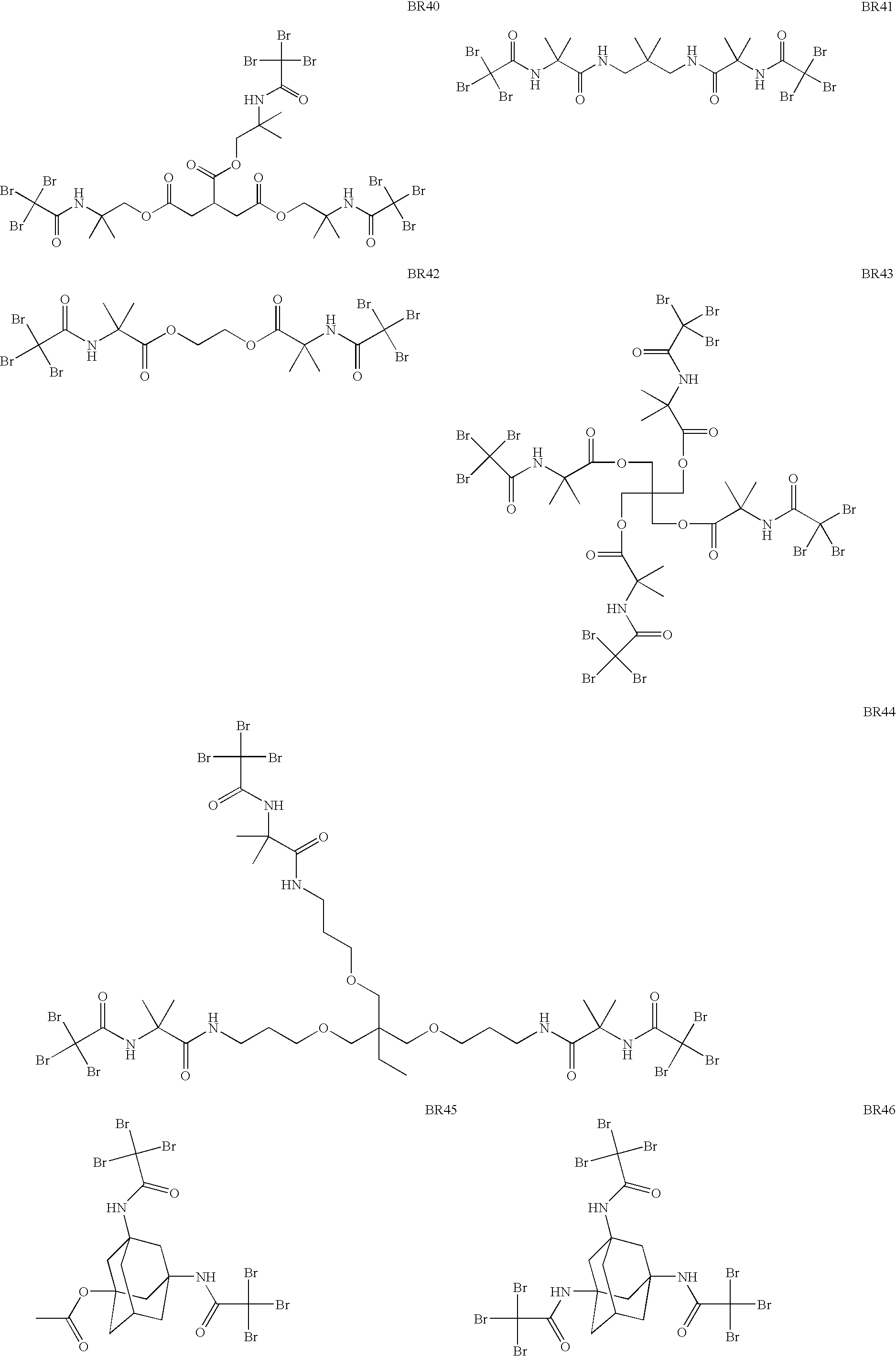

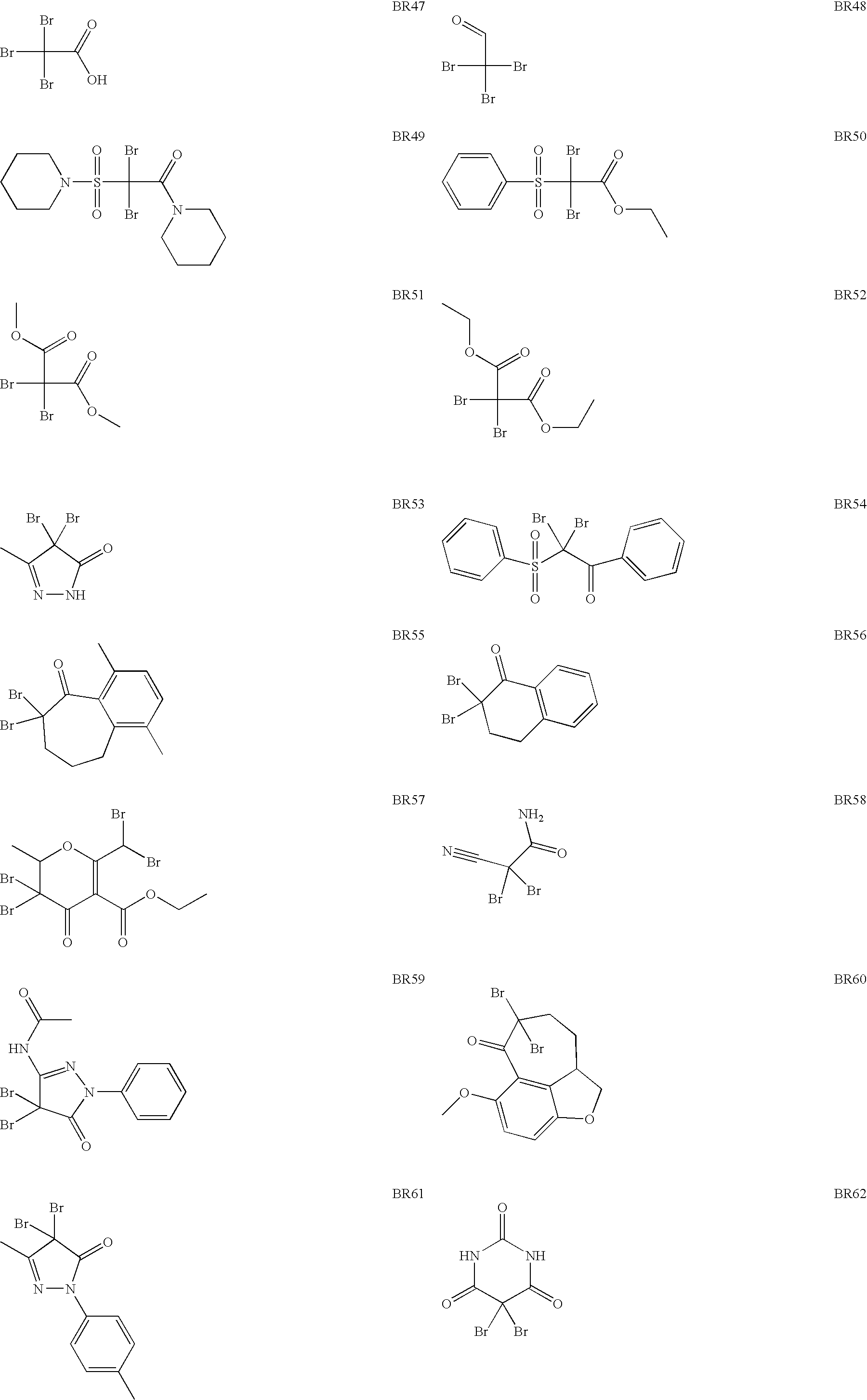

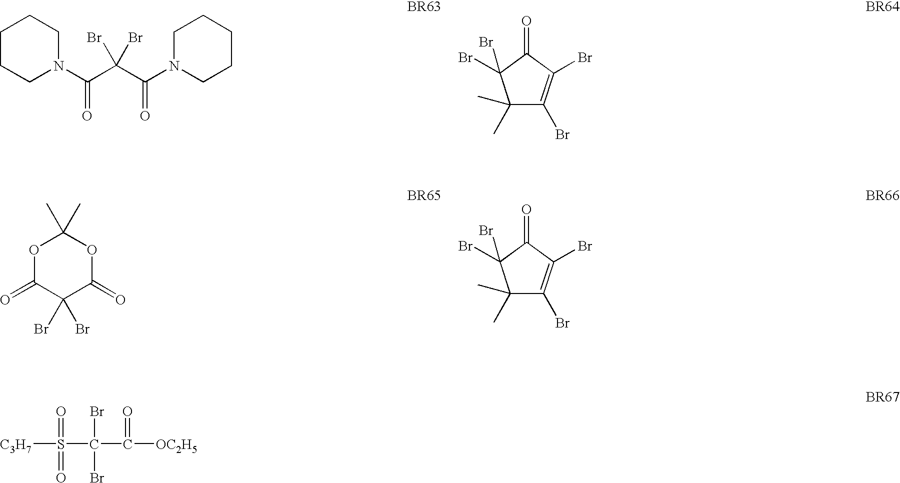

Other examples of the compounds will be listed below.

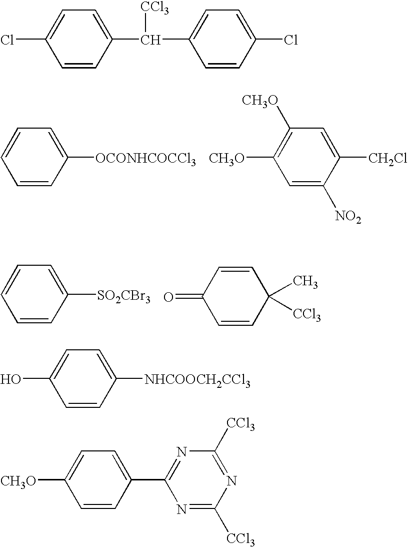

Fourthly, an iron arene complex is cited. In the invention, an iron arene complex is preferably used. An iron arene complex used in the invention is preferably a compound represented by formula (a) below.
[A-Fe—B]⁺X⁻ Formula (a)
wherein A represents a cyclopentadienyl group or an alkyl-substituted cyclopentadienyl group; B represents arene; and X⁻ is an anion.

Arene is a compound with an aromatic ring, and examples thereof include benzene, toluene, xylene, cumene, naphthalene, 1-methylnaphtalene, 2-methylnaphtalene, biphenyl, and fluorene. Examples of X⁻ include PF₆⁻, BF₄⁻, SbF₆⁻, AlF₄⁻, and CF₃SO₃⁻.

As the iron arene complexes, there are those described in Japanese Patent O.P.I. Publication No. 59-219307. Preferred examples of the iron arene complex include η-benzene-(η-cyclopentadienyl)iron.hexafluorophosphate, η-cumene)-(η-cyclopentadienyl)iron.hexafluorophosphate, η-fluorene-(η-cyclopentadienyl)iron.hexafluorophosphate, η-naphthalene-(η-cyclopentadienyl)iron.hexafluorophosphate, η-xylene-(η-cyclopentadienyl)iron.hexafluorophosphate, and η-benzene-(η-cyclopentadienyl)iron.hexafluoroborate.

The acid generating agent content of the light sensitive layer is preferably from 0.1 to 20% by weight, and more preferably from 0.1 to 10% by weight, based on the total weight of the cationically monomer.

(Dye Having Absorption Maximum in the Wavelength Regions of from 350 to 440 nm)

As a first example of a dye (hereinafter also referred to as the dye in the invention) having absorption maximum in the wavelength regions of from 350 to 440 nm, there is a dye represented by formula (2) above.

In formula (2), R¹¹, R¹², R¹³, R¹⁴, R¹⁵ and R¹⁶ independently represent a hydrogen atom, an alkyl group (for example, a methyl group, an ethyl group, a propyl group, an isopropyl group, a t-butyl group, a pentyl group, a hexyl group, an octyl group, a dodecyl group, a tridecyl group, a tetradecyl group, or a pentadecyl group), a cycloalkyl group (for example, a cyclopentyl group or a cyclohexyl group), an alkenyl group (for example, a vinyl group or a allyl group), an alkinyl group (for example, a propargyl group), an aryl group (for example, a phenyl group, or a naphthyl group), a heteroaryl group (for example, a furyl group, a thienyl group, a pyridazinyl group, a pyrimidinyl group, a pyrazinyl group, a triazinyl group, an imidazolyl group, a pyrazolyl group, a thiazolyl group, a benzimidazolyl group, a benzoxazolyl group, a quinazolyl group, or a phthalazinyl group), a saturated heterocyclic group (for example, a pyrrolidinyl group, an imidazolidinyl group, a morpholinyl group or an oxazolidinyl group), an alkoxy group (for example, a methoxy group, an ethoxy group, a propoxy group, a pentyloxy group, a hexyloxy group, an octyloxy group, or a dodecyloxy group), a cycloalkoxy group (for example, a cyclopentyloxy group, or a cyclohexyloxy group), an aryloxy group (for example, a phenoxy group or a naphthyloxy group), an alkylthio group (for example, a methylthio group, an ethylthio group, a propylthio group, a pentylthio group, a hexylthio group, an octylthio group, or a dodecylthio group), a cycloalkylthio group (for example, a cyclopentylthio group or a cyclohexylthio group), an arylthio group (for example, a phenylthio group, or a naphthylthio group), an alkoxycarbonyl group (for example, a methyloxycarbonyl group, an ethyloxycarbonyl group, a butyloxycarbonyl group, an octyloxycarbonyl group, or a dodecyloxycarbonyl group), an aryloxycarbonyl group (for example, a phenyloxycarbonyl group, or a naphthyloxycarbonyl group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, or a 2-pyridylaminosulfonyl group), an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecycarbonyl group, a phenylcarbonyl group, a naphthylcarbonyl group, or a pyridylcarbonyl group), an acyloxy group (for example, an acetyloxy group, an ethylcarbonyloxy group, a butylcarbonyloxy group, an octylcarbonyloxy group, a dodecycarbonyloxy group, or a phenylcarbonyloxy group), an amido group (for example, a methylcarbonylamino group, an ethylcarbonylamino group, a dimethylcarbonylamino group, a propylcarbonylamino group, a pentylcarbonylamino group, a cyclohexylcarbonylamino group, 2-ethylhexylcarbonylamino group, an octylcarbonylamino group, a a dodecycarbonylamino group, a phenylcarbonylamino group, a naphthylcarbonylamino group, or a pyridylcarbonyl group), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecyaminocarbonyl group, a phenylaminocarbonyl group, a naphthylaminocarbonyl group, or a 2-pyridylaminocarbonyl group), a ureido group (for example, a methylureido group, an ethylureido group, a pentylureido group, a cyclohexylureido group, an octylureido group, a dodecylureido group, a phenylureido group, a naphthylureido group, or a 2-pyridylureido group), a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, or a 2-pyridylsulfinyl group), an alkylsulfonyl group (for example, a methylsulfonyl group, an ethylsulfonyl group, a butylsulfonyl group, a cyclohexylsulfonyl group, a 2-ethylhexylsulfonyl group, or a dodecylsulfonyl group), an arylsulfonyl group (for example, a phenylsulfonyl group, a naphthylsulfonyl group, or a 2-pyridylsulfonyl group), an amino group (for example, an amino group, an ethylamino group, a dimethylamino group, a butylaminocarbonyl group, a cyclopentylamino group, a 2-ethylhexylamino group, a dodecyamino group, an anilino group, a naphthylamino group, or a 2-pyridylamino group), a halogen atom (for example, fluorine, chlorine, or bromine), a cyano group, a nitro group, a hydroxyl group, or a halogenated alkyl group (for example, a trifluoromethyl group, a tribromomethyl group, or a trichloromethyl group). These can have the same group as above as a substituent. Any adjacent two of R¹¹, R¹², R¹³, R¹⁴, R¹⁵ and R¹⁶ may combine with each other to form a ring.

Coumarin compounds are preferred in which in formula (2), R¹⁵ is an amino group or a substituted amino group such as an alkylamino group, a dialkylamino group, an arylamino group, a diarylamino group, or an alkylarylamino group. The coumarin compounds are preferably used in which the alkyl substituent of the substituted amino group in R¹⁵ combines with R¹⁴ or R¹⁶ to form a ring.

Coumarin compounds are more preferred in which in addition to the above, at least one of R¹¹ and R¹² is an alkyl group (for example, a methyl group, an ethyl group, a propyl group, an isopropyl group, a t-butyl group, a pentyl group, a hexyl group, an octyl group, a dodecyl group, a tridecyl group, a tetradecyl group, or a pentadecyl group), a cycloalkyl group (for example, a cyclopentyl group or a cyclohexyl group), an alkenyl group (for example, a vinyl group or an allyl group), an aryl group (for example, a phenyl group, or a naphthyl group), a heteroaryl group (for example, a furyl group, a thienyl group, a pyridazinyl group, a pyrimidinyl group, a pyrazinyl group, a triazinyl group, an imidazolyl group, a pyrazolyl group, a thiazolyl group, a benzimidazolyl group, a benzoxazolyl group, a quinazolyl group, or a phthalazinyl group), a saturated heterocyclic group (for example, a pyrrolidinyl group, an imidazolidinyl group, a morpholinyl group or an oxazolidinyl group), an alkoxycarbonyl group (for example, a methyloxycarbonyl group, an ethyloxycarbonyl group, a butyloxycarbonyl group, an octyloxycarbonyl group, or a dodecyloxycarbonyl group), an aryloxycarbonyl group (for example, a phenyloxycarbonyl group, or a naphthyloxycarbonyl group), an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecycarbonyl group, a phenylcarbonyl group, a naphthylcarbonyl group, or a pyridylcarbonyl group), an acyloxy group (for example, an acetyloxy group, an ethylcarbonyloxy group, a butylcarbonyloxy group, an octylcarbonyloxy group, a dodecycarbonyloxy group, or a phenylcarbonyloxy group), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecyaminocarbonyl group, a phenylaminocarbonyl group, a naphthylaminocarbonyl group, or a 2-pyridylaminocarbonyl group), a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, or a 2-pyridylsulfinyl group), an alkylsulfonyl group (for example, a methylsulfonyl group, an ethylsulfonyl group, a butylsulfonyl group, a cyclohexylsulfonyl group, a 2-ethylhexylsulfonyl group, or a dodecylsulfonyl group), an arylsulfonyl group (for example, a phenylsulfonyl group, a naphthylsulfonyl group, or a 2-pyridylsulfonyl group), a halogen atom (for example, fluorine, chlorine, or bromine), a cyano group, a nitro group or a halogenated alkyl group (for example, a trifluoromethyl group, a tribromomethyl group, or a trichloromethyl group).

Preferred examples will be listed below, but the invention is not limited thereto.

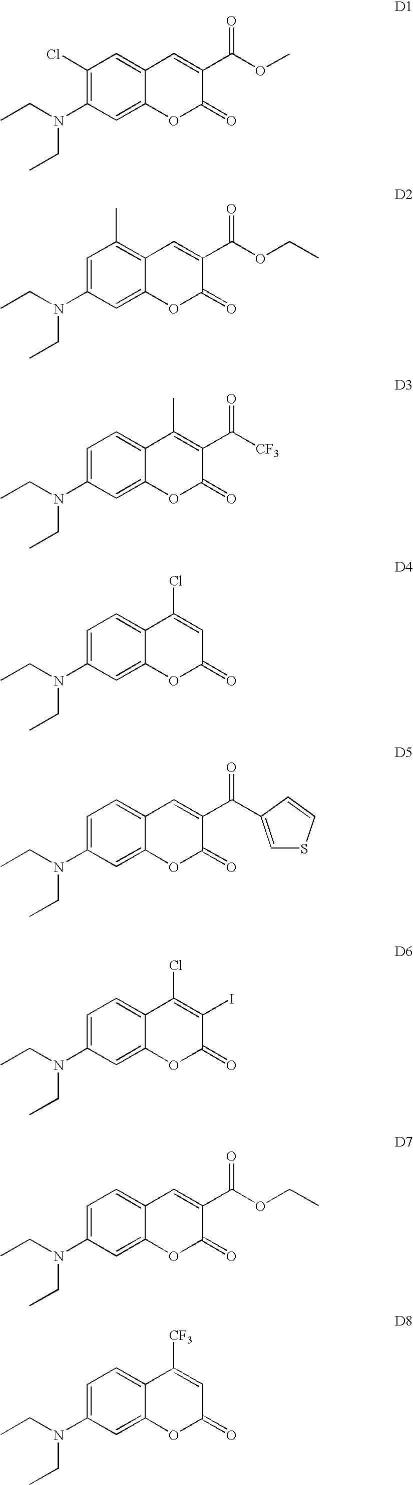

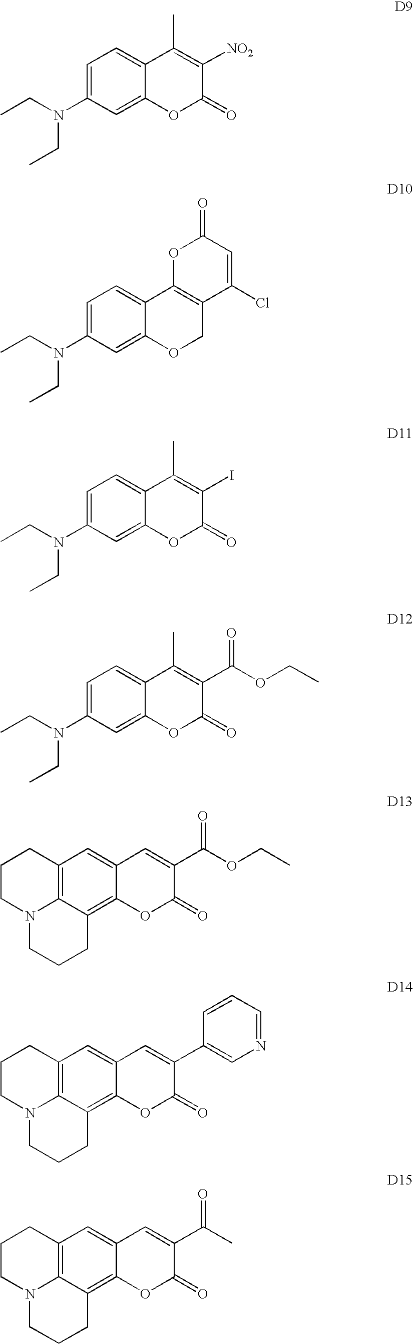

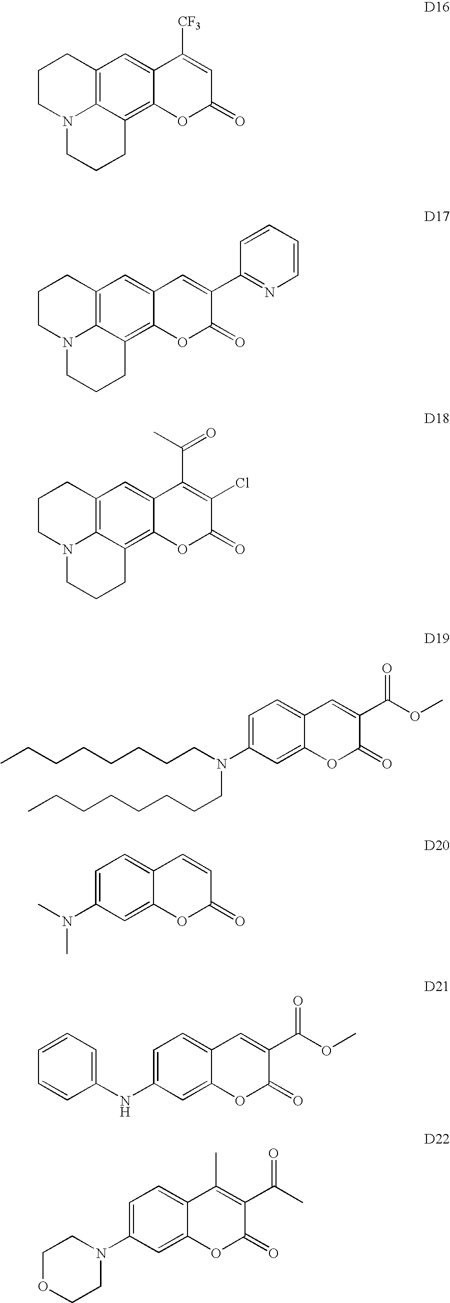

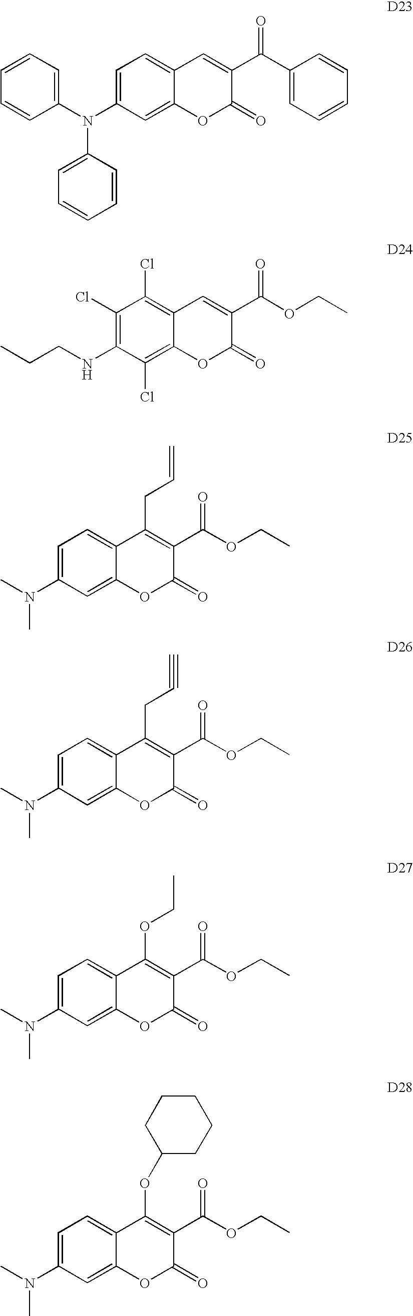

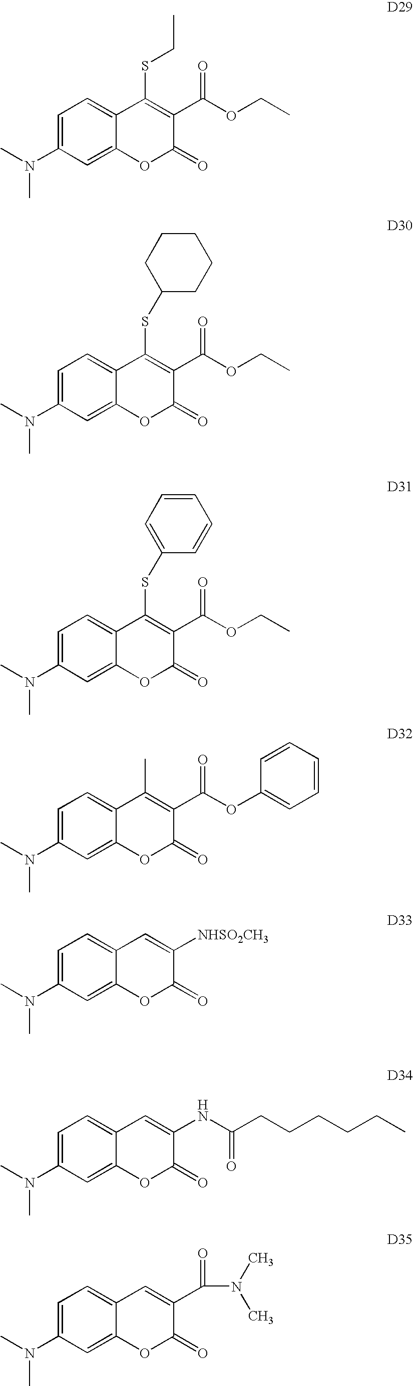

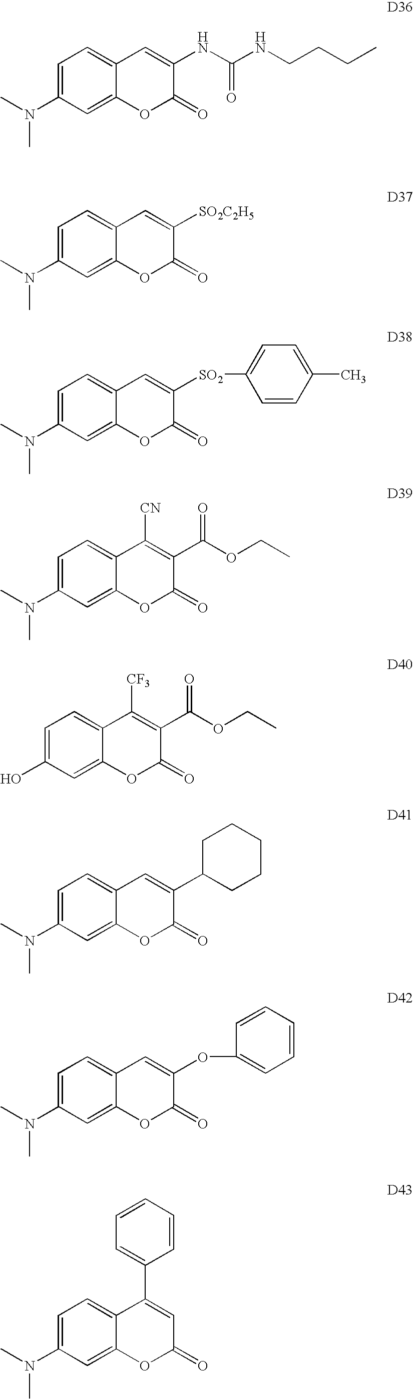

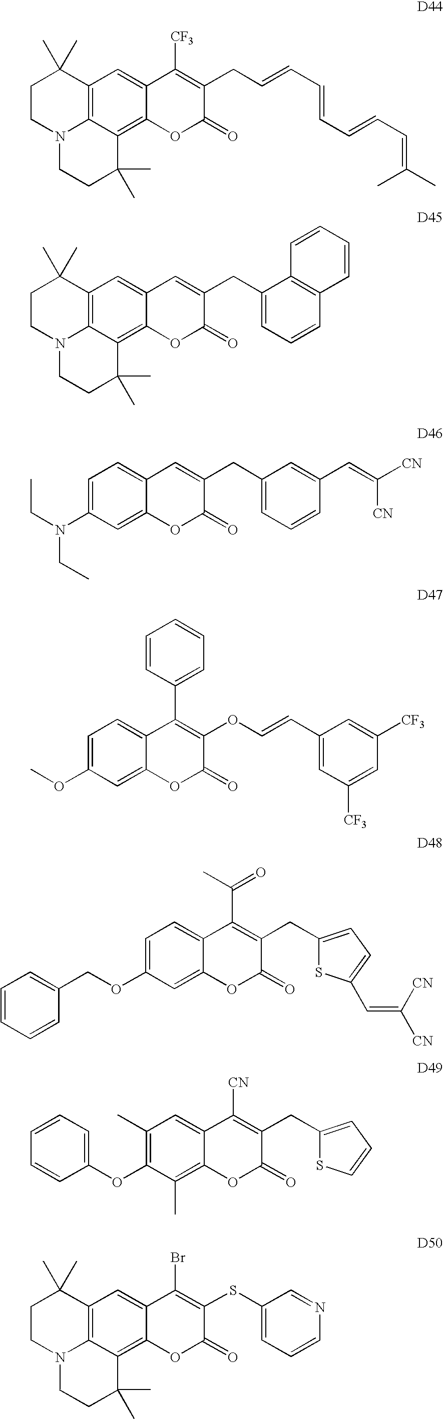

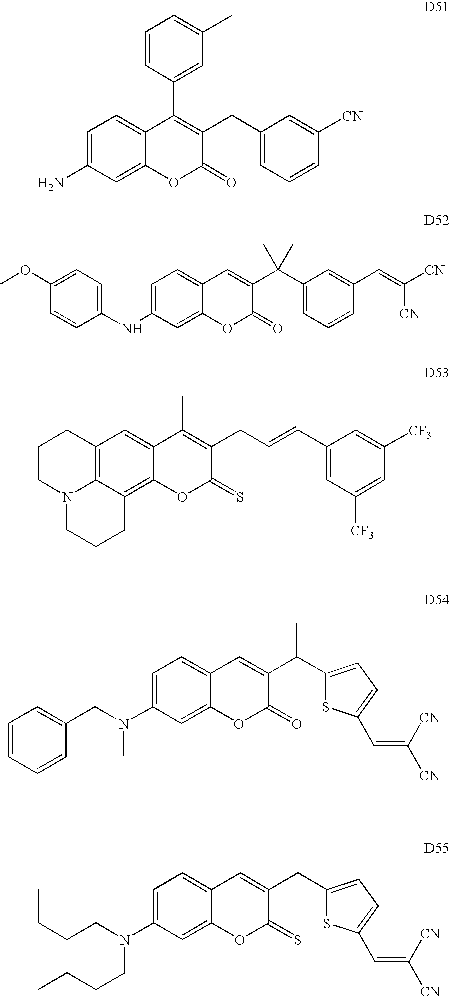

Besides the examples described above, there can be used coumarin derivatives B-1 through B-22 disclosed in Japanese Patent O.P.I. Publication No. 8-129258, coumarin derivatives D-1 through D-32 disclosed in Japanese Patent O.P.I. Publication No. 2003-12901, coumarin derivatives 1 through 21 disclosed in Japanese Patent O.P.I. Publication No. 2002-363206, coumarin derivatives 1 through 40 disclosed in Japanese Patent O.P.I. Publication No. 2002-363207, coumarin derivatives 1 through 34 disclosed in Japanese Patent O.P.I. Publication No. 2002-363208, or coumarin derivatives 1 through 56 disclosed in Japanese Patent O.P.I. Publication No. 2002-363209.

The content in the light-sensitive layer of the dye having absorption maximum in the wavelength regions of from 350 to 440 nm represented by formula (2) is preferably an amount which provides a reflection density of from 0.1 to 1.2, measured employing light used for exposure.

In formula (3) above, R²¹, R²² and R²³ independently represent a hydrogen atom and a substituent, provided that R²¹ and R²² may combine with each other to form a ring or R²² and R²³ may combine with each other to form a ring. The substituent represented by R²¹, R²² and R²³ is a substituted or unsubstituted alkyl group, a substituted or unsubstituted alkenyl group, a substituted or unsubstituted aryl group, or a substituted or unsubstituted heterocyclic group. Examples of the substituted or unsubstituted alkyl group, the substituted or unsubstituted alkenyl group, the substituted or unsubstituted aryl group or the substituted or unsubstituted heterocyclic group represented by R²¹, R²² and R²³ include for example, a methyl group, an ethyl group, a propyl group, a butyl group, an isopropyl group, an isobutyl group, an isopentyl group, tert-butyl group, a vinyl group, a 2-propenyl group, a 3-butenyl group, a phenyl group, a naphthyl group, a pyrrole ring, an imidazole ring, a pyrazole ring, an oxazole ring, a thiazole ring, an oxadiazole ring, a thiadiazole ring, a benzimidazole ring, a pyridine ring, a furan ring, a thiophene ring, a coumarone ring, a coumarin ring, a pyrrolidone ring, a piperidine ring, a morpholine ring, a sulfolane ring, a tetrahydrofuran ring, and a tetrahydropyrane ring.

The dye represented by formula (3) is preferably a dye represented by formula (6) below.

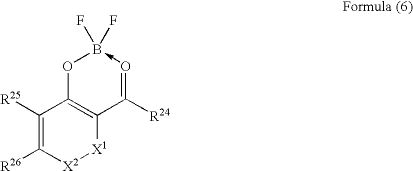

In formula (6), R²⁴ represents a hydrogen atom, a substituted or unsubstituted alkyl group, a substituted or unsubstituted alkenyl group, a substituted or unsubstituted aryl group, or a substituted or unsubstituted heterocyclic group; R²⁵ and R²⁶ combine with each other to form a 6- to 10-membered aromatic ring; and X¹ and X² independently represent —CR²⁷R²⁸—, —O—, —S—, or —NR²⁹—, in which R²⁷, R²⁸, and R²⁹ independently represent a hydrogen atom, a substituted or unsubstituted alkyl group, a substituted or unsubstituted alkenyl group, a substituted or unsubstituted aryl group, or a substituted or unsubstituted heterocyclic group.

Examples of the substituted or unsubstituted alkyl group represented by R²⁴ include a methyl group, an ethyl group, a propyl group, a butyl group, a hexyl group, an octyl group, a decyl group, a dodecyl group, an isopropyl group, an isobutyl group, an isopentyl group, a tert-butyl group or a 2-ethylhexyl group. Examples of the substituted or unsubstituted alkenyl group represented by R²⁴ include a vinyl group, a 2-propenyl group, or a 3-butenyl group, a 1-methyl-3-propenyl group, 3-pentenyl group, a 1-methyl-3-butenyl group or a 4-hexenyl group. Examples of the substituted or unsubstituted aryl group represented by R²⁴ include a phenyl group or a naphthyl group. Examples of the substituted or unsubstituted heterocyclic group represented by R²⁴ include heterocyclic groups derived from 5- or 6-membered heterocyclic rings such as a pyrrole ring, an imidazole ring, a pyrazole ring, an oxazole ring, a thiazole ring, an oxadiazole ring, a thiadiazole ring, a benzimidazole ring, a pyridine ring, a furan ring, a thiophene ring, a coumarone ring, a coumarin ring, a pyrrolidone ring, a piperidine ring, a morpholine ring, a sulfolane ring, a tetrahydrofuran ring, and tetrahydropyrane.

Examples of the substituted or unsubstituted alkyl group, the substituted or unsubstituted alkenyl group the substituted or unsubstituted aryl group or the substituted or unsubstituted heterocyclic group represented by R²⁷, R²⁸ or R²⁹ are the same as those denoted in R²⁴ above.

Typical examples of the compound represented by formula (6) will be listed below.

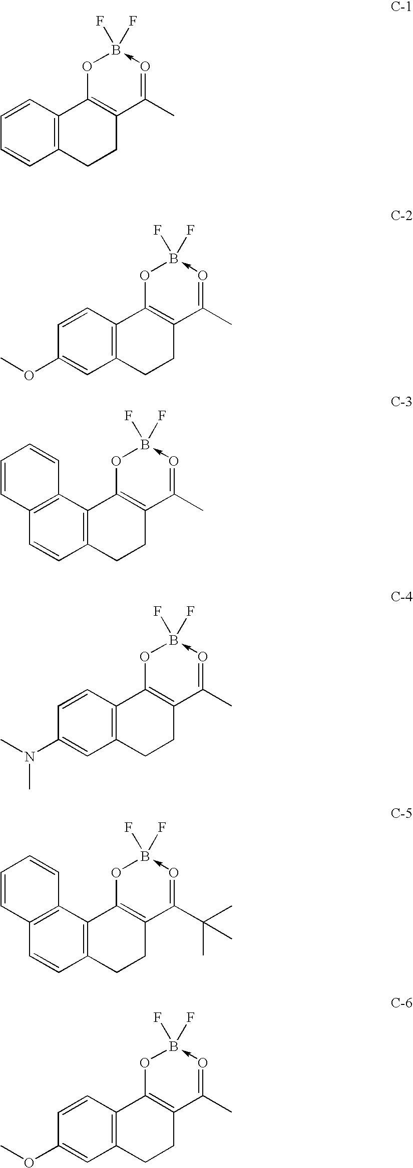

The dye having absorption maximum in the wavelength regions of from 350 to 440 nm represented by formula (4) is preferably a dye represented by formula (4-1), (4-2) or (4-3) below,

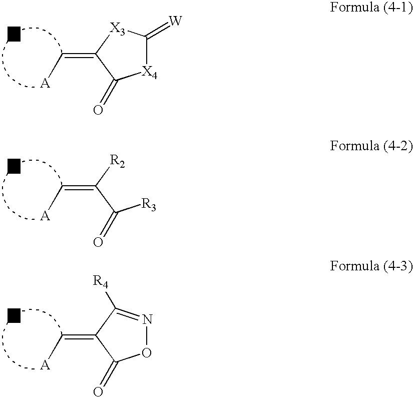

In formula (4-1), (4-2) or (4-3), A and Z are the same as those denoted in A and Z of formula (4) above. X₃, X₄ and W independently represent an oxygen atom, a sulfur atom or —NR₅— in which R₅ represents a substituted or unsubstituted alkyl group or a substituted or unsubstituted aryl group; R₂ represents a hydrogen atom, a substituted or unsubstituted alkyl group, a substituted or unsubstituted alkoxy group, a substituted or unsubstituted aryloxy group, a substituted or unsubstituted arylcarbonyl group, a substituted or unsubstituted arylthiocarbonyl group, a substituted or unsubstituted alkylthio group, a substituted or unsubstituted arylthio group, a substituted or unsubstituted alkylamino group, or a substituted or unsubstituted arylamino group; R₃ represents a hydrogen atom, a substituted or unsubstituted alkyl group, a substituted or unsubstituted aryl group, a substituted or unsubstituted heteroaryl group, a substituted or unsubstituted alkoxy group, a substituted or unsubstituted aryloxy group, a substituted or unsubstituted alkylthio group, a substituted or unsubstituted arylthio group, a substituted or unsubstituted alkylamino group or a substituted or unsubstituted arylamino group; and R₄ represents a hydrogen atom, a substituted or unsubstituted alkyl group, a substituted or unsubstituted aryl group, or a substituted or unsubstituted heteroaryl group.

Formulae (4), (4-1), (4-2) and (4-3) will be explained in detail below.

A represents a sulfur atom or —NR₁— in which R₁ represents a substituted or unsubstituted alkyl group or a substituted or unsubstituted aryl group, and Z represents a non-metallic atom group necessary to form an basic nucleus together with A. Preferred examples of R₁ will be explained below.

Preferred examples of the unsubstituted alkyl group include a straight-chained, branched or cyclic alkyl group each having a carbon atom number of from 1 to 20, for example, a methyl group, an ethyl group, a propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methylhexyl group, cyclohexyl group, a cyclopentyl group, and 2-norbornyl group. Among these, a straight-chained alkyl group having a carbon atom number of from 1 to 12, a branched alkyl group having a carbon atom number of from 3 to 12 or a cyclic alkyl group having a carbon atom number of from 5 to 10 is especially preferred.

The substituent of the substituted alkyl group is a monovalent non-metallic group except for a hydrogen atom. Preferred examples of the substituent include a halogen atom (—F, —Br, —Cl, —I), a hydroxyl group, an alkoxy group, an aryloxy group, a mercapto group, an alkylthio group, an arylthio group, an alkyldithio group, an aryldithio group, an amino group, an N-alkylamino group, an N, N-dialkylamino group, an N-arylamino group, an N, N-diarylamino group, an N-alkyl-N-arylamino group, an acyloxy group, a carbamoyloxy group, an N-alkylcarbamoyloxy group, an N-arylcarbamoyloxy group, an N, N-dialkylcarbamoyloxy group, an N, N-diarylcarbamoyloxy group, an N-alkyl-N-arylcarbamoyloxy group, an alkylsulfoxy group, an arylsulfoxy group, an acylthio group, an acylamino group, an N-alkylacylamino group, an N-arylacylamino group, a ureido group, an N′-alkylureido group, an N′, N′-dialkylureido group, an N′-arylureido group, an N′, N′-diarylureido group, an N′-alkyl-N′-arylureido group, an N-alkylureido group, an N-arylureido group, an N′-alkyl-N-alkylureido group, an N′-alkyl-N-arylureido group, an N′, N′-dialkyl-N-alkylureido group, an N′, N′-dialkyl-N-arylureido group, an N′-aryl-N-alkylureido group, an N′-aryl-N-arylureido group, an N′, N′-diaryl-N-alkylureido group, an N′, N′-diaryl-N-arylureido group, an N′-alkyl-N′-aryl-N-alkylureido group, an N′-alkyl-N′-aryl-N-arylureido group, an alkoxycarbonylamino group, an aryloxycarbonylamino group, an N-alkyl-N-alkoxycarbonylamino group, an N-alkyl-N-aryloxycarbonylamino group, an N-aryl-N-alkoxycarbonylamino group, an N-aryl-N-aryloxycarbonylamino group, a formyl group, an acyl group, a carboxyl group, an alkoxycarbonyl group, an aryloxycarbonyl group, a carbamoyl group, an N-alkylcarbamoyl group, an N, N-dialkylcarbamoyl group, an N-arylcarbamoyl group, an N, N-diaryl carbamoyl group, an N-alkyl-N-arylcarbamoyl group, an alkylsulfinyl group, an arylsulfinyl group, an alkylsulfonyl group, an arylsulfonyl group, a sulfo group (—SO₃H) and its conjugate base group (hereinafter referred to as a sulfonato group), an alkoxysulfonyl group, an aryloxysulfonyl group, a sulfinamoyl group, an N-sulfinamoyl group, an N, N-dialkylsulfinamoyl group, an N-aryl sulfinamoyl group, an N, N-diarylsulfinamoyl group, an N-alkyl-N-arylsulfinamoyl group, a sulfamoyl group, an N-alkylsulfamoyl group, an N, N-dialkylsulfamoyl group, an N-arylsulfamoyl group, an N, N-diarylsulfamoyl group, an N-alkyl-N-arylsulfamoyl group, a phosphono group (—PO₃H₂) and its conjugate base group (hereinafter referred to as a phosphonato group), a dialkylphosphono group (—PO₃(alkyl)₂), a diarylphosphono group (—PO₃(aryl)₂), an alkylarylphosphono group (—PO₃(alkyl)(aryl)), a monoalkylphosphono group (—PO₃H(alkyl)) and its conjugate base group (hereinafter also referred to as an alkylphosphonato group), a monoarylphosphono group (—PO₃H(aryl)) and its conjugate base group (hereinafter referred to as an arylphosphonato group), a phosphonoxy group (—OPO₃H₂) and its conjugate base group (hereinafter also referred to as a phophonatoxy group), a dialkylphosphonoxy group (—OPO₃(alkyl)₂), a diarylphosphonoxy group (—OPO₃(aryl)₂), an alkylarylphosphonoxy group (—OPO₃(alkyl)(aryl)), a monoalkylphosphonoxy group (—OPO₃H(alkyl)) and its conjugate base group (hereinafter referred to as an alkylphosphonatoxy group), a monoarylphosphonoxy group (—OPO₃H(aryl)) and its conjugate base group (hereinafter referred to as an arylphosphonatoxy group), a cyano group, a nitro group, an aryl group, an alkenyl group, and an alkynyl group.

Examples of the alkyl in the substituent described above are the same as those denoted above in the examples of the unsubstituted alkyl group. Examples of the aryl group include a phenyl group, a biphenyl group, a naphthyl group, a tolyl group, a xylyl group, a mesityl group, a cumenyl group, a chlorophenyl group, a bromophenyl group, a chloromethylphenyl group, a hydroxyphenyl group, a methoxyphenyl group, an ethoxyphenyl group, a phenoxyphenyl group, a acetoxyphenyl group, a benzoyloxyphenyl group, a methylthiophenyl group, a phenylthiophenyl group, a methylaminophenyl group, a dimethylaminophenyl group, an acetylaminophenyl group, a carboxyphenyl group, a methoxycarbonylphenyl group, an ethoxycarbonylphenyl group, a phenoxycarbonylphenyl group, an N-phenylcarbamoylphenyl group, a phenyl group, a cyanophenyl group, a sulfophenyl group, a sulfonatophenyl group, a phosphonophenyl group, and a phosphonatophenyl group. Examples of the heteroaryl group include a monocyclic or polycyclic aromatic ring group containing in the ring at least one of a nitrogen atom, an oxygen atom and a sulfur atom, and are preferably a 5- or 6-membered aromatic ring group such as a furyl group, a pyrrolyl group or a pyridyl group.

Examples of the alkenyl group include a vinyl group, a 1-propenyl group, a 1-butenyl group, a cinnamyl group and a 2-chloro-1-ethenyl group. Examples of the alkinyl group include an ethynyl group, 1-propynyl group, a 1-butynyl group and a trimethylsilylethynyl group. The acyl group is represented by G₁CO— in which G₁ represents a hydrogen atom, the alkyl group described above or the aryl group described above.

Among these, more preferred is a halogen atom (—F, —Br, —Cl, —I), an alkoxy group, an aryloxy group, an alkylthio group, an arylthio group, an N-alkylamino group, an N, N-dialkylamino group, an acyloxy group, an N-alkylcarbamoyloxy group, an N-arylcarbamoyloxy group, an acylamino group, a formyl group, an acyl group, a carboxyl group, an alkoxycarbonyl group, an aryloxycarbonyl group, a carbamoyl group, an N-alkylcarbamoyl group, an N, N-dialkylcarbamoyl group, an N-arylcarbamoyl group, a sulfo group, a sulfonato group, a sulfamoyl group, an N-alkylsulfamoyl group, an N, N-dialkylsulfamoyl group, an N-arylsulfamoyl group, an N-alkyl-N-arylsulfamoyl group, a phosphono group a phosphonato group, a dialkylphosphono group, a diarylphosphono group, a monoalkylphosphono group, an alkylphosphonato group, a monoarylphosphono group, an arylphosphonato group, a phosphonoxy group, a phophonatoxy group, an aryl group or an alkenyl group.

The alkylene group in the substituted alkyl group is a divalent organic residue obtained by subtracting any one of the hydrogens in the alkyl group as described above having a carbon atom number of from 1 to 20, and preferably a straight-chained alkylene group having a carbon atom number of from 1 to 12, a branched alkylene group having a carbon atom number of from 3 to 12, or a cyclic alkylene group having a carbon atom number of from 5 to 10.

Preferred examples of the substituted alkyl group of R₁ obtained by a combination of the substituent and the alkylene group include a chloromethyl group, a bromomethyl group, a 2-chloroethyl group, a trifluoromethyl group, a methoxymethyl group, a methoxyethoxymethyl group, an allyloxymethyl group, a phenoxymethyl group, a methylthiomethyl group, a tolylthiomethyl group, an ethylaminoethyl group, a diethylaminopropyl group, a morpholinopropyl group, an acetyloxymethyl group, a benzoyloxymethyl group, an N-cyclohexylcarbamoyloxyethyl group, an N-phenylcarbamoyloxyethyl group, an acetylaminoethyl group, an N-methylbenzoylaminopropyl group, a 2-oxoethyl group, a 2-oxopropyl group, a carboxypropyl group, a methoxycarbonylethyl group, an allyloxycarbonylbutyl group, a chlorophenoxycarbonylmethyl group, a carbamoylmethyl group, an N-methylcarbamoylethyl group, an N,N-dipropylcarbamoylethyl group, an N-(methoxyphenyl)carbamoylethyl group, an N-methyl-N-(sulfophenyl)carbamoylmethyl group, a sulfobutyl group, a sulfonatobutyl group, a sulfamoylbutyl group, an N-ethylsulfamoylmethyl group, an N,N-dipropylsulfamoylpropyl group, an N-tolylsulfamoylpropyl group, an N-methyl-N-(phosphonophenyl)sulfamoyloctyl group, a phosphonobutyl group, a phosphonatohexyl group, a diethylphosphonobutyl group, a diphenylphosphonopropyl group, a methylphosphonobutyl group, a methylphosphonatobutyl group, a tolylphosphonohexyl group, a tolylphosphonatohexyl group, a phophonoxypropyl group, a phophonatoxybutyl group, a benzyl group, a phenethyl group, an α-methylbenzyl group, a 1-methyl-1-phenylethyl group, a p-methylbenzyl group, a cinnamyl group, an allyl group, a 1-propenylmethyl group, a 2-butenyl group, a 2-methylallyl group, a 2-methylpropenylmethyl group, a 2-propynyl group, a 2-butenyl group, and a 3-butenyl group.

Preferred examples of the aryl group of R₁ include a benzene ring group, a condensed ring group comprised of two or three benzene rings, a condensed ring group comprised of a benzene ring and a 5-membered unsaturated ring, for example, a phenyl group, a naphthyl group, an anthryl group, a phenanthryl group, an indenyl group, an acenaphthenyl group, or a fluorenyl group. Among these, a phenyl group or a naphthyl group is especially preferred.

Preferred examples of the substituted aryl group of R₁ include those having a monovalent organic group (except for a hydrogen atom) on the ring forming carbon atom of the aryl group described above. The preferred examples of the substituent of the substituted aryl group include the same as those denoted in the alkyl group above, those denoted the substituted alkyl group above and those denoted in the substituent of the substituted alkyl group above. Preferred examples of the substituted aryl group include a biphenyl group, a tolyl group, a xylyl group, a mesityl group, a cumenyl group, a chlorophenyl group, a bromophenyl group, a fluorophenyl group, a chloromethylphenyl group, a trifluolomethylphenyl group, a hydroxyphenyl group, a methoxyphenyl group, a methoxyethoxyphenyl group, an allyloxyphenyl group, a phenoxyphenyl group, a methylthiophenyl group, a tolylthiophenyl group, an ethylaminophenyl group, a diethylaminophenyl group, a morphlinophenyl group, an acetyloxyphenyl group, a benzoyloxyphenyl group, an N-cyclohexylcarbamoyloxyphenyl group, an N-phenylcarbamoyloxyphenyl group, an acetylaminophenyl group, an N-methylbenzoylaminophenyl group, a carboxyphenyl group, a methoxycarbonylphenyl group, an ethoxycarbonylphenyl group, an allyloxycarbonylphenyl group, a chlorophenoxycarbonylphenyl group, a carbamoylphenyl group, a N-methylcarbamoylphenyl group, an N,N-dipropylcarbamoylphenyl group, an N-(methoxyphenyl)carbamoylphenyl group, an N-methyl-N-(sulfophenyl)carbamoylphenyl group, a sulfophenyl group, a sulfonatophenyl group, a sulfamoylphenyl group, an N-ethylsulfamoylphenyl group, an N,N-dipropylsulfamoylphenyl group, an N-tolylsulfamoylphenyl group, an N-methyl-N-(phosphonophenyl)sulfamoylphenyl group, a phosphonophenyl group, a phosphonatophenyl group, a diethylphosphonophenyl group, a diphenylphosphonophenyl group, a methylphosphonophenyl group, a methylphosphonatophenyl group, a tolylphosphonophenyl group, a tolylphosphonatophenyl group, an allylphenyl group, a 1-propenylmethylphenyl group, a 2-butenylphenyl group, a 2-methylallylphenyl group, a 2-methylpropenylphenyl group, a 2-propynylphenyl group, and a 2-butynylphenyl group.

Z in formula (4) will be explained below. Z represents a nonmetallic atom group necessary to form a heterocyclic ring together with A. Such a heterocyclic ring is preferably a 5-, 6-, or 7-membered nitrogen-containing or sulfur-containing heterocyclic ring, and more preferably a 5- or 6-membered nitrogen-containing or sulfur-containing heterocyclic ring.

Examples of the nitrogen-containing heterocyclic ring include heterocyclic rings (basic nuclei) constituting merocyanine dyes disclosed in L. G. Brooker et al., J. Am. Chem. Soc., 73, 5326-5358 (1951) or literatures cited therein.

Examples of the basic nuclei include thiazoles (for example, thiazole, 4-methylthiazole, 4-phenylthiazole, 5-methylthiazole, 5-phenylthiazole, 4,5-dimethylthiazole, 4,5-diphenylthiazole, 4,5-di(p-methoxyphenyl)thiazole, 4-(2-thienyl)thiazole, etc.), benzothiazoles (for example, benzothiazole, 4-chlorobenzothiazole, 5-chlorobenzothiazole, 6-chlorobenzothiazole, 7-chlorobenzothiazole, 4-methylbenzothiazole, 5-methylbenzothiazole, 6-methylbenzothiazole, 4-bromobenzothiazole, 4-phenylbenzothiazole, 5-phenylbenzothiazole, 4-methoxybenzothiazole, 5-methoxybenzothiazole, 6-methoxybenzothiazole, 5-iodobenzothiazole, 6-iodobenzothiazole, 4-ethoxybenzothiazole, 5-ethoxybenzothiazole, tetrahydrobenzothiazole, 5,6-dimethoxybenzothiazole, 5,6-doxymethylenebenzothiazole, 5-hydroxybenzothiazole, 6-hydroxybenzothiazole, 6-dimethylaminobenzothiazole, 5-ethoxycarbonylbenzothiazole, etc.), naphthothiazoles (for example, naphtho[1,2]thiazole, naphtho[2,1]thiazole, 5-methoxynaphtho[2,1]thiazole, 5-ethoxynaphtho[2,1]thiazole, 8-methoxynaphtho[1,2]thiazole, 7-methoxynaphtho[1,2]thiazole, etc.), thianaphtheno-7′,6′,4,5-thiazoles (for example, 4′-methoxythianaphtheno-7′,6′,4,5-thiazoles, etc.), oxazoles (for example, 4-methyloxazole, 5-methyloxazole, 4-phenyloxazole, 4,5-diphenyloxazole, 4-ethyloxazole, 4,5-dimethyloxazole, 5-phenyloxazole, etc.), benzoxazoles (for example, benzoxazole, 5-chlorobenzoxazole, 5-methylbenzoxazole, 5-phenylbenzoxazole, 6-methylbenzoxazole, 5,6-dimethylbenzoxazole, 4,6-dimethylbenzoxazole, 6-methoxybenzoxazole, 5-methoxybenzoxazole, 4-ethoxybenzoxazole, 5-chlorobenzoxazole, 6-methoxybenzoxazole, 5-hydroxybenzoxazole, 6-hydroxybenzoxazole, etc.), naphthoxazoles (for example, naphtho[1,2]oxazoles, naphtho[2,1]oxazoles, etc.), selenazoles (for example, 4-methylselenazole, 4-phenylselenazole, etc.), benzoselenazoles (for example, benzoselenazole, 5-chlorobenzoselenazole, 5-methoxybenzoselenazole, 5-hydroxybenzoselenazole, tetrahydrobenzoselenazole, etc.), naphthobenzoselenazoles (for example, naphtho[1,2]benzoselenazole, naphtho[2,1]benzoselenazole, etc.), thiazolines (for example, thiazoline, 4-methylthiazoline, etc.), 2-quinolines (for example, quinoline, 3-methylquinoline, 5-methylquinoline, 7-methylquinoline, 8-methylquinoline, 6-chloroquinoline, 8-chloroquinoline, 6-methoxyquinoline, 6-ethoxyquinoline, 6-hydroxyquinoline, 8-hydroxyquinoline, etc.), 4-quinolines (for example, quinoline, 6-methoxyquinoline, 7-methylquinoline, 8-methylquinoline, etc.), 1-isoquinolines (for example, isoquinoline, 3,4-dihydroisoquinoline, etc.), 3-isoquinolines (for example, isoquinoline, etc.), benzimidazoles (for example, 1,3-diethylbenzimidazole, 1-ethyl-3-phenylbenzimidazole, etc.), 3,3-dialkylindolenines (for example, 3,3-dimethylindolenine, 3,3,5-trimethylindolenine, 3,3,7-trimethylindolenine, etc.), 2-pyridines (for example, pyridine, 5-methylpyridine, etc.), and 5-pyridines (for example, pyridine, etc.).

As examples of the sulfur-containing heterocyclic ring, there are dithiol partial structure constituting dyes disclosed in Japanese Patent O.P.I. Publication No. 3-296759. Examples of the dithiol partial structure include benzodithiols (for example, benzodithiol, 5-t-butylbenzodithiol, 5-methylbenzodithiol, etc.), naphthodithiols (for example, naphtho[1,2]dithiol, naphtho[2,1]dithiol, etc.), and dithiols (for example, 4,5-dimethyldithiols, 4-phenyldithiols, 4-methoxycarbonyldithiols, 4,5-dimethoxycarbonylbenzodithiols, 4,5-ditrifluoromethyldithiol, 4,5-dicyanodithiol, 4-methoxycarbonylmethyldithiol, 4-carboxymethyldithiol, etc.).

Among dyes represented by formula (4), (4-1), (4-2) or (4-3), dyes are preferred in providing high sensitivity and high storage stability, which have, as the nitrogen-containing or sulfur-containing heterocyclic ring formed by Z and A and represented by the following partial structural formula (I), a heterocyclic ring group represented by the following partial structural formula (I-A)

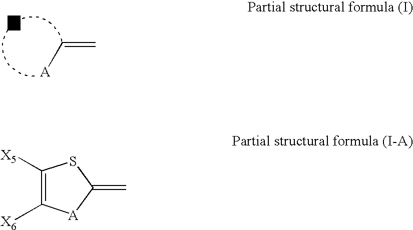

In formula (I-A), A is the same as those denoted in A of formula (4) above, and X₅ and X₆ independently represent a substituted or unsubstituted alkyl group, a substituted or unsubstituted aryl group or a substituted or unsubstituted heteroaryl group, provided that X₅ and X₆ may combine with each other to form a 5-, 6- or 7-membered ring. Examples of X₅ and X₆ include those denoted in the substituted or unsubstituted alkyl group or aryl group of R₁ above.

X₁ and X₂ in formula (4) will explained below.

X₁ and X₂ independently represent a hydrogen atom or a monovalent non-metallic group, for example, a halogen atom (—F, —Br, —Cl, —I), a hydroxyl group, an alkoxy group, an aryloxy group, a mercapto group, an alkylthio group, an arylthio group, an alkyldithio group, an aryldithio group, an amino group, an N-alkylamino group, an N, N-dialkylamino group, an N-arylamino group, an N, N-diarylamino group, an N-alkyl-N-arylamino group, an acyloxy group, a carbamoyloxy group, an N-alkylcarbamoyloxy group, an N-arylcarbamoyloxy group, an N, N-dialkylcarbamoyloxy group, an N, N-diarylcarbamoyloxy group, an N-alkyl-N-arylcarbamoyloxy group, an alkylsulfoxy group, an arylsulfoxy group, an acylthio group, an acylamino group, an N-alkylacylamino group, an N-arylacylamino group, a ureido group, an N′-alkylureido group, an N′, N′-dialkylureido group, an N′-arylureido group, an N′, N′-diarylureido group, an N′-alkyl-N′-arylureido group, an N-alkylureido group, an N-arylureido group, an N′-alkyl-N-alkylureido group, an N′-alkyl-N-arylureido group, an N′, N′-dialkyl-N-alkylureido group, an N′, N′-dialkyl-N-arylureido group, an N′-aryl-N-alkylureido group, an N′-aryl-N-arylureido group, an N′, N′-diaryl-N-alkylureido group, an N′, N′-diaryl-N-arylureido group, an N′-alkyl-N′-aryl-N-alkylureido group, an N′-alkyl-N′-aryl-N-arylureido group, an alkoxycarbonylamino group, an aryloxycarbonylamino group, an N-alkyl-N-alkoxycarbonylamino group, an N-alkyl-N-aryloxycarbonylamino group, an N-aryl-N-alkoxycarbonylamino group, an N-aryl-N-aryloxycarbonylamino group, a formyl group, an acyl group, a carboxyl group, an alkoxycarbonyl group, an aryloxycarbonyl group, a carbamoyl group, an N-alkylcarbamoyl group, an N, N-dialkylcarbamoyl group, an N-arylcarbamoyl group, an N, N-diaryl carbamoyl group, an N-alkyl-N-arylcarbamoyl group, an alkylsulfinyl group, an arylsulfinyl group, an alkylsulfonyl group, an arylsulfonyl group, a sulfo group (—SO₃H) and its conjugate base group (hereinafter referred to as a sulfonato group), an alkoxysulfonyl group, an aryloxysulfonyl group, a sulfinamoyl group, an N-sulfinamoyl group, an N, N-dialkylsulfinamoyl group, an N-aryl sulfinamoyl group, an N, N-diarylsulfinamoyl group, an N-alkyl-N-arylsulfinamoyl group, a sulfamoyl group, an N-alkylsulfamoyl group, an N, N-dialkylsulfamoyl group, an N-arylsulfamoyl group, an N, N-diarylsulfamoyl group, an N-alkyl-N-arylsulfamoyl group, a phosphono group (—PO₃H₂) and its conjugate base group (hereinafter referred to as a phosphonato group), a dialkylphosphono group (—PO₃(alkyl)₂), a diarylphosphono group (—PO₃(aryl)₂), an alkylarylphosphono group (—PO₃(alkyl)(aryl)), a monoalkylphosphono group (—PO₃H(alkyl)) and its conjugate base group (hereinafter also referred to as an alkylphosphonato group), a monoarylphosphono group (—PO₃H(aryl)) and its conjugate base group (hereinafter referred to as an arylphosphonato group), a phosphonoxy group (—OPO₃H₂) and its conjugate base group (hereinafter also referred to as a phophonatoxy group), a dialkylphosphonoxy group (—OPO₃(alkyl)₂), a diarylphosphonoxy group (—OPO₃(aryl)₂), an alkylarylphosphonoxy group (—OPO₃(alkyl)(aryl)), a monoalkylphosphonoxy group (—OPO₃H(alkyl)) and its conjugate base group (hereinafter referred to as an alkylphosphonatoxy group), a monoarylphosphonoxy group (—OPO₃H(aryl)) and its conjugate base group (hereinafter referred to as an arylphosphonatoxy group), a cyano group, a nitro group, a substituted or unsubstituted aryl group, an alkenyl group, and an alkynyl group.

X₁ and X₂ may combine with each other to form a ring such as an acidic nucleus constituting merocyanine dyes disclosed in L. G. Brooker et al., J. Am. Chem. Soc., 73, 5326-5358 (1951) or literatures cited therein described above.

Examples of the acidic nuclei include a 1,3-dicarbonyl nucleus (for example, 1,3-indanedione, 1,3-cyclohexanedione, 5,5-dimethylcyclohexanedione, 1,3-dioxane-4,6-dione, etc.), a pyrazolinone nucleus 3-methyl-1-phenyl-2-pyrazoline-5-one, 1-phenyl-2-pyrazoline-5-one, 1-(2-benzothiazolyl)-3-methyl-2-pyrazoline-5-one, etc.), an isoxazolinone nucleus (for example, 3-phenyl-2-oxazoline-5-one, 3-methyl-2-oxazoline-5-one, etc.), an oxindole nucleus (1-alkyl-2,3-dihydro-oxindole, etc.), a 2,4,6-trioxohexahydropyrimidine nucleus (for example, barbituric acid, 2-thio barbituric acid and their N-substituted derivatives such as 1,3-diethylbarbituric acid, 1,3-diethyl-2-thiobarbituric acid, 1,3-dibutylbarbituric acid, 1,3-dibutyl-2-thiothiobarbituric acid, 1,3-diphenylbarbituric acid, 1,3-diphenyl-2-thiobarbituric acid, 1,3-dimethoxycarbonylmethylbarbituric acid, 1,3-dimethoxycarbonylmethyl-2-thiobarbituric acid, etc.), a 2-thio-2,4-thiazolidinedione nucleus (for example, rhodamine and its N-substituted derivatives such as 3-methylrhodanine, 3-ethylrhodanine, 3-phenylrhodanine, 3-allylrhodanine, 3-benzylrhodanine, 3-carboxymethylrhodanine, 3-carboxyethylrhodanine, 3-methoxycarbonylmethylrhodanine, 3-hydroxyethylrhodanine, 3-morpholinoethylrhodanine, etc.), 2-thio-2,4-oxazolidinedione nucleus (for example, 2-thio-2,4-(3H, 4H)-oxazolidinedione such as 2-ethyl-2-thio-2,4-oxazolidinedione, etc.), a thianaphthenone nucleus (for example, 3(2H)-thianaphthenone, 3(2H)-thianaphthenone-1,1-dioxide, etc.), a 2-thio-2,5-thiazolidinedione nucleus (for example, 3-ethyl-2-thio-2,5-thiazolidinedione, etc.), a 2,4-thiazolidinedione nucleus (for example, 2,4-thiazolidinedione, 3-ethyl-2,4-thiazolidinedione, 3-phenyl-2,4-thiazolidinedione, etc.), a thiazolidinone nucleus (for example, 4-thiazolidinone, 3-ethyl-4-thiazolidinone, 2-ethylmercapto-4-thiazolidinone, 2-methylphenylamino-4-thiazolidinone, etc.), a 2-imono-2-oxazoline-4-one nucleus (for example, a pseudo hydantoin nucleus), a 2,4-imidazolinedione nucleus (for example, a hydantoin nucleus such as 2,4-imidazolinedione, 3-ethyl-2,4-imidazolinedione, 1,3-diethyl-2,4-imidazolinedione, etc.), a 2-thio-2,4-imidazolinedione nucleus (for example, a thiohydantoin nucleus such as 2-thio-2,4-imidazolinedione, 3-ethyl-2-thio-2,4-imidazolinedione, 1,3-diethyl-2-thio-2,4-imidazolinedione, etc.), an imidazoline-5-one nucleus (for example, 2-propylmercapto-2-imidazoline-5-one, etc.), a furane-5-one nucleus, a 4-hydroxy-2(1H)-pyridinone nucleus (for example, N-methyl-4-hydroxy-2(1H)-pyridinone, N-methyl-4-hydroxy-2(1H)-quinolinone, N-butyl-4-hydroxy-2(1H)-quinolinone, etc.), a 4-hydroxy-2H-pyrane-2-one nucleus (for example, 4-hydroxycoumarin, etc.), and a thioindoxyl nucleus (for example, 5-methylthioindoxyl, etc.). These acidic nuclei may have a substituent.

A dye is especially preferred, which in formula (4) the following partial structural formula (II) is replaced by the following structural formula (II-B), (II-C) or (II-D).

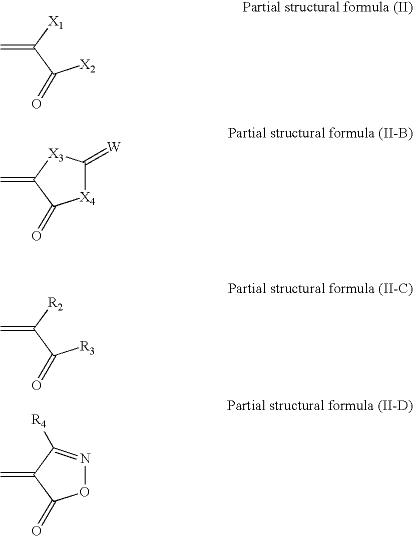

In formulae (II-B), (II-C) and (II-D), X₃, X₄, W, R₂, R₃, and R₄ are the same as those denoted in X₃, X₄, W, R₂, R₃, and R₄ of formulae (4-1), (4-2) and (4-3) described above.

Amond dyes described above, dyes having partial structural formula (II-C) in the molecule are more preferred.

Examples of dyes in the invention will be listed below, which are represented by formulae E-1 through E-60, but the invention is not limited thereto.

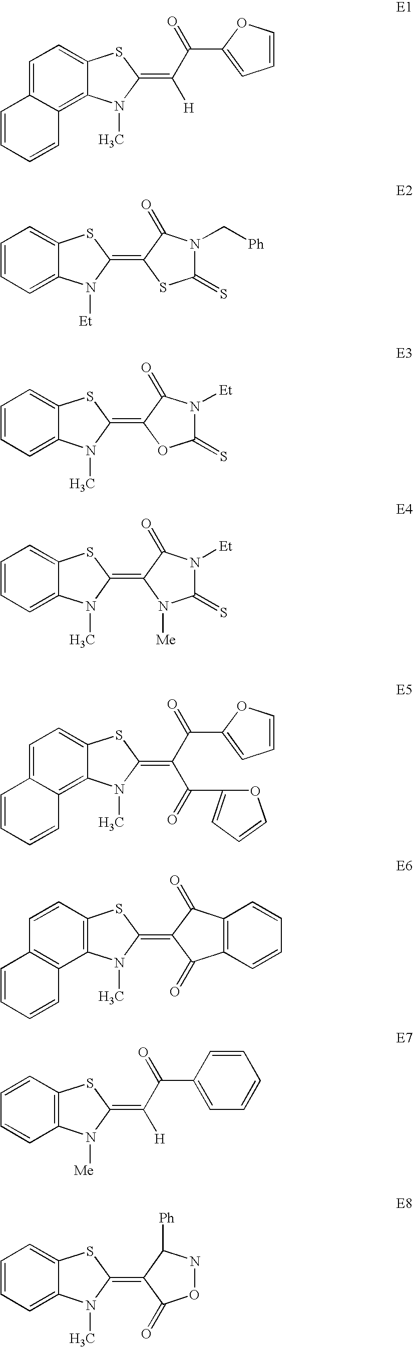

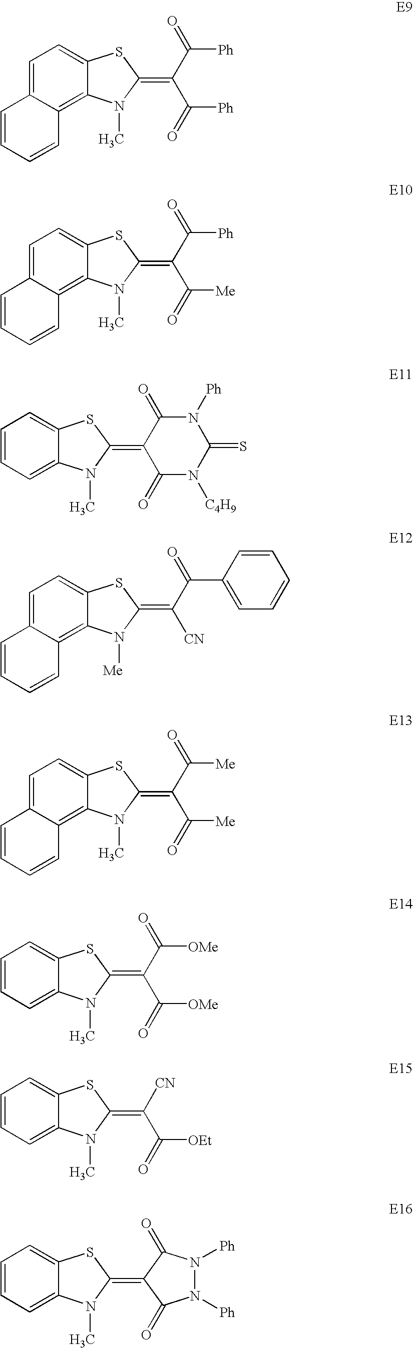

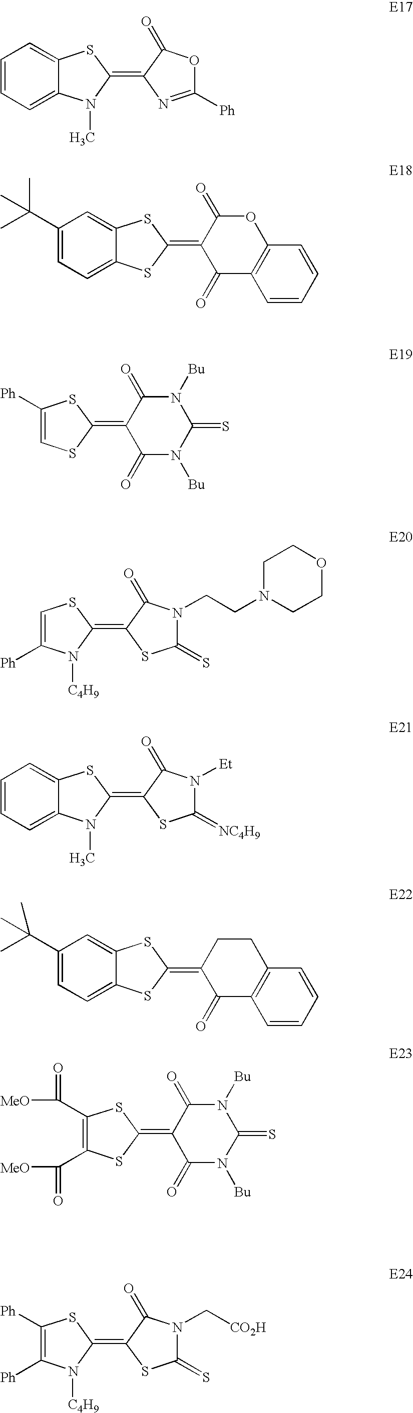

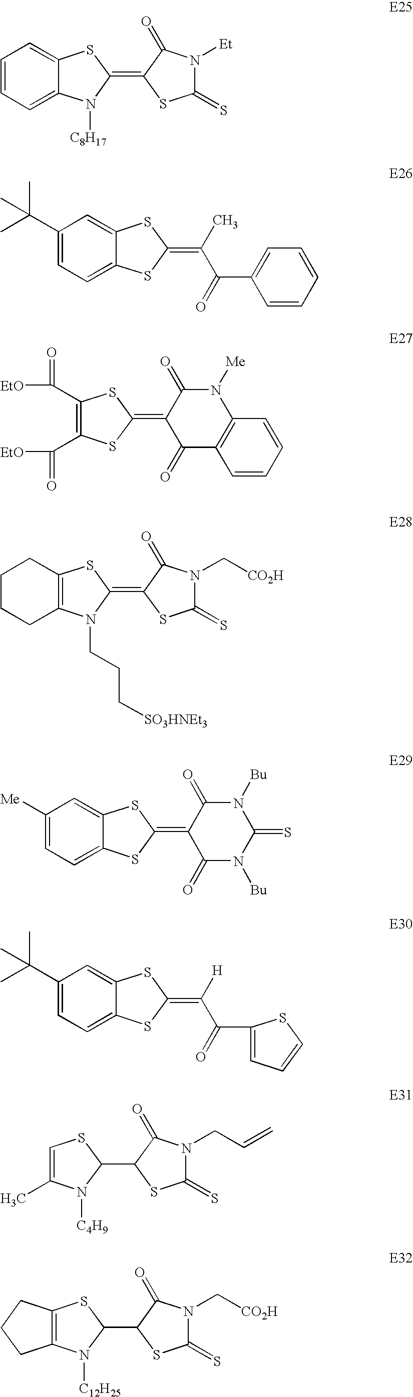

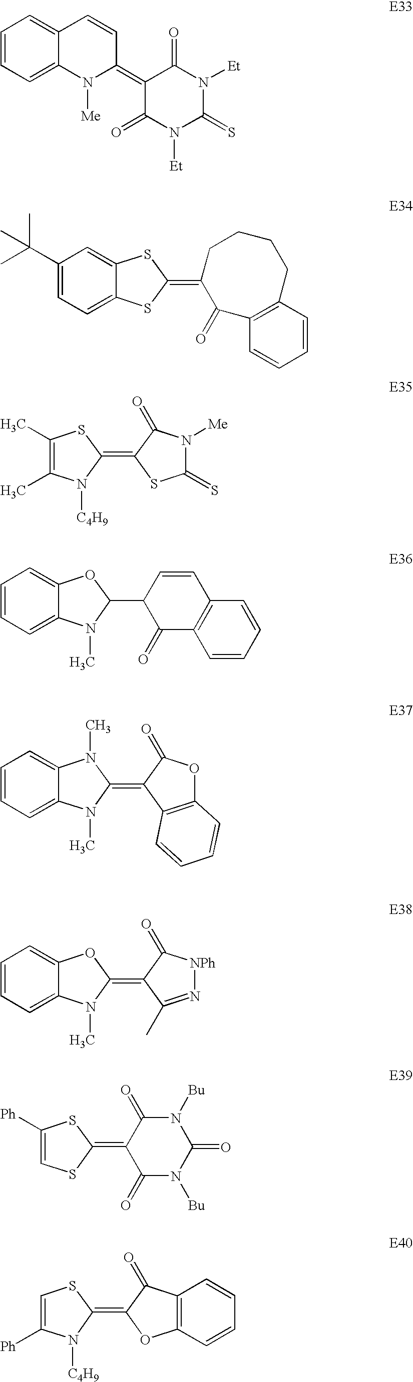

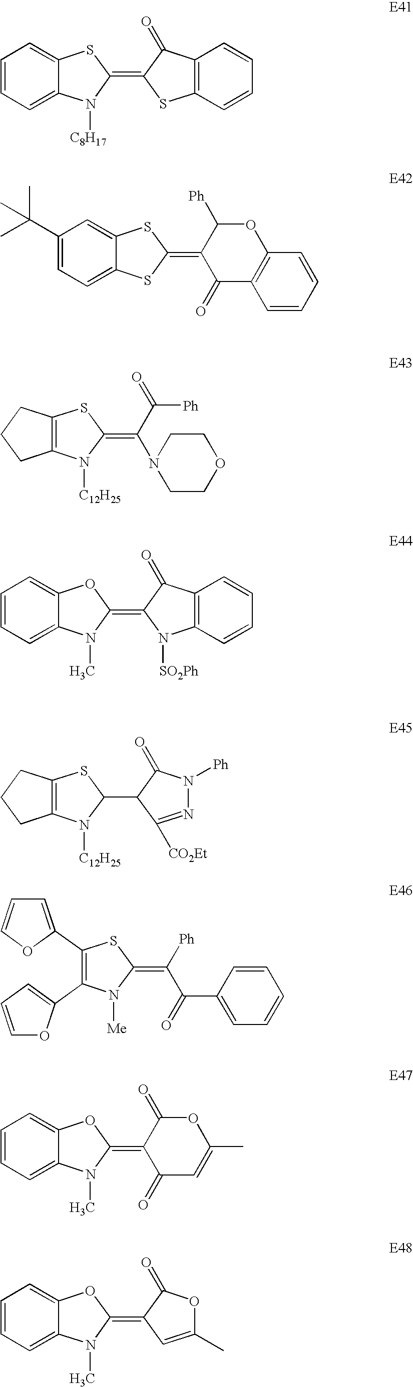

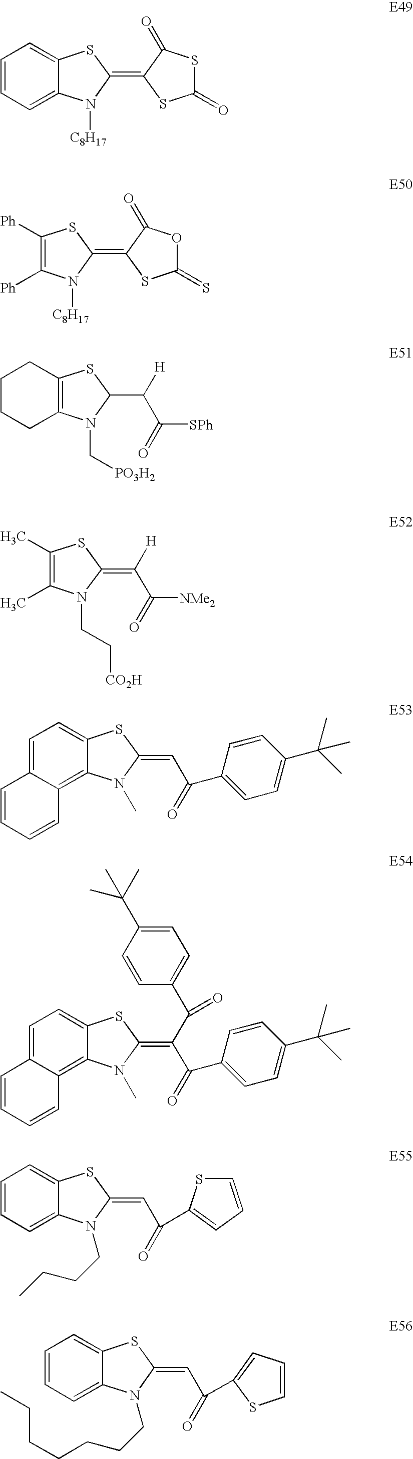

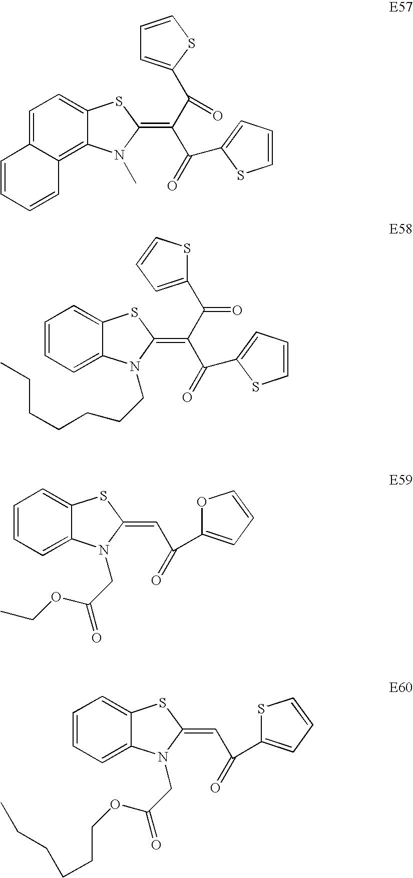

The dyes in the invention represented by formula (4), (4-1), (4-2) or (4-4) can be synthesized according to methods disclosed in F. M. Hamer et al., “The Cyanine Dyes and Related Compounds”, 511-611 (1964) or in KAI ARNE JENSEN and LARS HENRIKSEN, “ACTACHEMICA SCANDINAVICA, 22, 1107-1128 (1968).

In the dye having absorption maximum in the wavelength regions of from 350 to 440 nm represented by formula (5), R³¹ represents an alkyl group, an aryl group, an alkenyl group, a cycloalkyl group, an aralkyl group or a heterocyclic group; R³² represents a hydrogen atom, an alkyl group, an aryl group, an alkenyl group, a cycloalkyl group, an aralkyl group or a heterocyclic group, R³¹ and R³² may combine with each other to form a ring; and R³³, R³⁴ and R³⁵ independently represent a hydrogen atom, an alkyl group, an alkoxy group, an aryloxy group, an alkylthio group, an arylthio group, a dialkylamino group or a diarylamino group. The above group represented by R³¹ through R³⁵ may have further a substituent. Examples of the dye represented by formula (5) will be listed below.

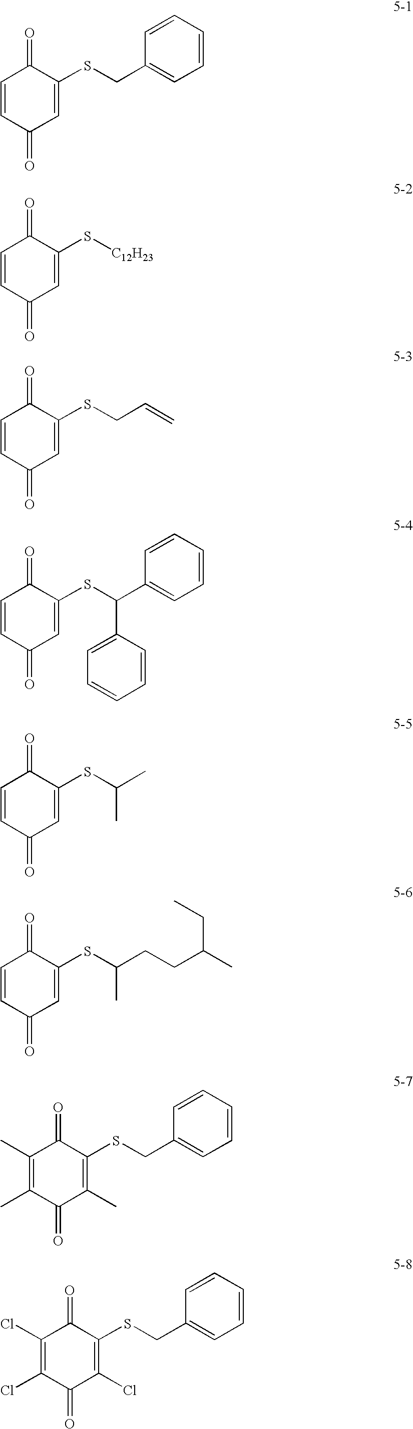

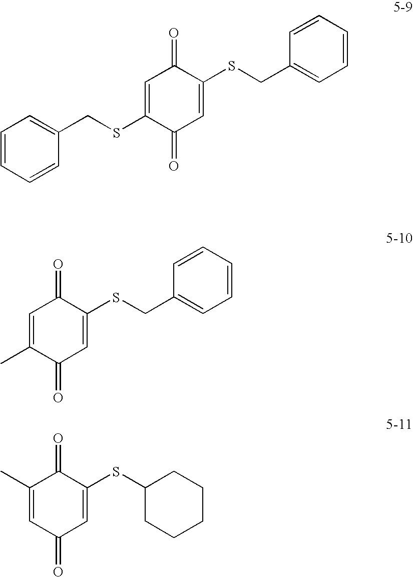

The dye in the invention having absorption maximum in the wavelength regions of from 350 to 440 nm can be chemically modified in order to improve properties of a light sensitive layer containing the dye. For example, a combination of such a dye and an addition polymerization inducing group (for example, an acryloyl group or a methacryloyl group) through covalent bond, ionic bond or hydrogen bond can increase strength of an exposed light sensitive layer and can prevent undesired separation of the dye from the light sensitive layer after exposure.

Further, incorporation of a hydrophilic group (an acidic group or a polar group such as a carboxyl group or its ester group, a sulfonic acid group or its ester group, or an ethyleneoxy group to the dye is effective. Particularly, the ester type hydrophilic group-containing dye has characteristics in that its compatibility in a light sensitive layer is excellent due to the relatively hydrophobic property, and generates an acid group due to hydrolysis in a developer to increase its hydrophilicity.

Furthermore, an appropriate group can be incorporated in the dye in order to increase compatibility in a light sensitive or to prevent dye separation from the light sensitive layer. For example, incorporation of an unsaturated group such as an aryl group or an allyl group is effective in increasing compatibility in a certain light sensitive layer, or incorporation of a branched alkyl group causes steric hindrance between the n planes of dyes, whereby the dye separation can be markedly restrained. Incorporation of a phosphonic acid group, an epoxy group or a trialkoxysilyl group can increase adhesion to inorganic substances such as metals or metal oxides. Besides the above, a polymer of the dye can be applied as necessary.

Use of the dye can be arbitrarily determined according to performance design of a light sensitive layer. For example, use of two or more kinds of the dye can increase compatibility in the light sensitive layer. When the dye is employed, sensitivity or molar extinction coefficient of the dye to light of a light source employed is an important factor. A dye having a large molar extinction coefficient is economical since its content in the light sensitive is comparatively small, and advantageous in layer properties of the light sensitive layer. Sensitivity, resolution or layer properties of a light sensitive layer are greatly influenced by absorbance to light of a light source. The addition amount of the dye in the light sensitive layer is determined considering the above. A light sensitive layer having a low absorbance such as an absorbance of not more than 0.1 decrease sensitivity, and lowers resolution due to halation. However, when a light sensitive layer having a large thickness such as a thickness of not less than 5 μm is cured, such a low absorbance may increase hardness of the cured light sensitive layer.

A light sensitive layer having a relatively high absorbance such as an absorbance of not less than 3 absorbs most of light on the light sensitive layer surface, and inhibits curing of the interior of the light sensitive layer. For example, when such a light sensitive layer is employed as a light sensitive layer of a printing plate material, its layer strength or its adherence to the substrate is insufficient. When a light sensitive layer having a relatively small thickness is applied to a planographic printing plate material, the dye content of the light sensitive layer is an amount providing an absorbance of the light sensitive layer of preferably from 0.1 to 1.5, and more preferably from 0.25 to 1. The dye content of the light sensitive layer of the planographic printing plate material is ordinarily from 0.05 to 30% by weight, preferably from 0.1 to 20% by weight, and more preferably from 0.2 to 10% by weight, based on the total weight of light sensitive layer.

(Alkali-Soluble Polymeric Binder)

The light sensitive layer of the planographic printing plate material of the invention contains an alkali-soluble polymeric binder.

As the alkali-soluble polymeric binder in the invention can be used a polyacrylate resin, a polyvinylbutyral resin, a polyurethane resin, a polyamide resin, a polyester resin, an epoxy resin, a phenol resin, a polycarbonate resin, a polyvinyl butyral resin, a polyvinyl formal resin, a shellac resin, or another natural resin. These resins can be used as an admixture of two or more thereof.

The alkali-soluble polymeric binder in the invention is preferably a vinyl copolymer obtained by copolymerization of an acryl monomer, and more preferably a copolymer containing, as the copolymerization component, (a) a carboxyl group-containing monomer unit and (b) an alkyl methacrylate or alkyl acrylate unit.

Examples of the carboxyl group-containing monomer include an α, β-unsaturated carboxylic acid, for example, acrylic acid, methacrylic acid, maleic acid, maleic anhydride, itaconic acid, itaconic anhydride or a carboxylic acid such as a half ester of phthalic acid with 2-hydroxymethacrylic acid.

Examples of the alkyl methacrylate or alkyl acrylate include an unsubstituted alkyl ester such as methylmethacrylate, ethylmethacrylate, propylmethacrylate, butylmethacrylate, amylmethacrylate, hexylmethacrylate, heptylmethacrylate, octylmethacrylate, nonylmethacrylate, decylmethacrylate, undecylmethacrylate, dodecylmethacrylate, methylacrylate, ethylacrylate, propylacrylate, butylacrylate, amylacrylate, hexylacrylate, heptylacrylate, octylacrylate, nonylacrylate, decylacrylate, undecylacrylate, or dodecylacrylate; a cyclic alkyl ester such as cyclohexyl methacrylate or cyclohexyl acrylate; and a substituted alkyl ester such as benzyl methacrylate, 2-chloroethyl methacrylate, N,N-dimethylaminoethyl methacrylate, glycidyl methacrylate, benzyl acrylate, 2-chloroethyl acrylate, N,N-dimethylaminoethyl acrylate or glycidyl acrylate.

The alkali-soluble polymeric binder in the invention can further contain, as another monomer unit, a monomer unit derived from the monomer described in the following items (1) through (14):

1) A monomer having an aromatic hydroxy group, for example, o-, (p- or m-) hydroxystyrene, or o-, (p- or m-) hydroxyphenylacrylate;

2) A monomer having an aliphatic hydroxy group, for example, 2-hydroxyethyl acrylate, 2-hydroxyethyl methacrylate, N-methylolacrylamide, N-methylolmethacrylamide, 4-hydroxybutyl acrylate, 4-hydroxybutyl methacrylate, 5-hydroxypentyl acrylate, 5-hydroxypentyl methacrylate, 6-hydroxyhexyl acrylate, 6-hydroxyhexyl methacrylate, N-(2-hydroxyethyl)acrylamide, N-(2-hydroxyethyl)methacrylamide, or hydroxyethyl vinyl ether;

3) A monomer having an aminosulfonyl group, for example, m- or p-aminosulfonylphenyl methacrylate, m- or p-aminosulfonylphenyl acrylate, N-(p-aminosulfonylphenyl) methacrylamide, or N-(p-aminosulfonylphenyl)acrylamide;

4) A monomer having a sulfonamido group, for example, N-(p-toluenesulfonyl)acrylamide, or N-(p-toluenesulfonyl)-methacrylamide;

5) An acrylamide or methacrylamide, for example, acrylamide, methacrylamide, N-ethylacrylamide, N-hexylacrylamide, N-cyclohexylacrylamide, N-phenylacrylamide, N-nitrophenylacrylamide, N-ethyl-N-phenylacrylamide, N-4-hydroxyphenylacrylamide, or N-4-hydroxyphenylmethacrylamide;

6) A monomer having a fluorinated alkyl group, for example, trifluoromethyl acrylate, trifluoromethyl methacrylate, tetrafluoropropyl methacrylate, hexafluoropropyl methacrylate, octafluoropentyl acrylate, octafluoropentyl methacrylate, heptadecafluorodecyl methacrylate, heptadecafluorodecyl methacrylate, or N-butyl-N-(2-acryloxyethyl)heptadecafluorooctylsulfonamide;

7) A vinyl ether, for example, ethyl vinyl ether, 2-chloroethyl vinyl ether, propyl vinyl ether, butyl vinyl ether, octyl vinyl ether, or phenyl vinyl ether;

8) A vinyl ester, for example, vinyl acetate, vinyl chroloacetate, vinyl butyrate, or vinyl benzoate;

9) A styrene, for example, styrene, methylstyrene, or chloromethystyrene;

10) A vinyl ketone, for example, methyl vinyl ketone, ethyl vinyl ketone, propyl vinyl ketone, or phenyl vinyl ketone;

11) An olefin, for example, ethylene, propylene, isobutylene, butadiene, or isoprene;

12) N-vinylpyrrolidone, N-vinylcarbazole, or N-vinylpyridine,

13) A monomer having a cyano group, for example, acrylonitrile, methacrylonitrile, 2-pentenenitrile, 2-methyl-3-butene nitrile, 2-cyanoethyl acrylate, or o-, m- or p-cyanostyrene;

14) A monomer having an amino group, for example, N,N-diethylaminoethyl methacrylate, N,N-dimethylaminoethyl acrylate, N,N-dimethylaminoethyl methacrylate, polybutadiene urethane acrylate, N,N-dimethylaminopropyl acrylamide, N,N-dimethylacrylamide, acryloylmorpholine, N-isopropylacrylamide, or N,N-diethylacrylamide.

Further another monomer may be copolymerized with the above monomer.

The above vinyl polymer can be manufactured according to a conventional solution polymerization, bulk polymerization or suspension polymerization. A polymerization initiator used is not specifically limited, but examples thereof include azo bis type radical generating agents, for example, 2,2′-azobisiso-butyronitrile (AIBN) or 2,2′-azobis(2-methylbutyronitrile. The amount used of the polymerization initiator is ordinarily from 0.05 to 10.0 part by weight (preferably from 0.1 to 5 part by weight), based on 100 parts by weight of monomer used to prepare a (co)polymer. As the solvents used in the solution polymerization, there are organic solvents including ketones, esters or aromatics, for example, good solvents generally used in the solution polymerization such as toluene, ethyl acetate, benzene, methylcellosolve, ethylcellosolve, acetone, and methyl ethyl ketone. Among these, ones having a boiling point of from 60 to 120° C. are preferred. The solution polymerization is ordinarily carried out at 40 to 120° C. (preferably 60 to 110° C.), for 3 to 10 hours (preferably 5 to 8 hours) employing the above solvents. After completion of polymerization, the solvents are removed from the resulting polymerization solution to obtain a (co)polymer. Alternatively, the polymerization solution is used without removing the solvents in a double bond incorporation reaction as described later which follows.

The molecular weight of the polymer can be adjusted by selecting solvents used or by controlling polymerization temperature. The solvents used or the polymerization temperature for obtaining a polymer with an intended molecular weight is appropriately determined by monomers used. The molecular weight of the polymer can be also adjusted by mixing the above solvents with a specific solvent. Examples of the specific solvent include mercaptans such as n-octylmercaptan, n-dodecylmercaptan, t-dodecylmercaptan and mercaptoethanol, and carbon chlorides such as carbon tetrachloride, butyl chloride and propylene chloride. The mixing ratio of the specific solvent to the solvents described above can be properly determined by monomers used, solvents used or polymerization conditions.

The polymer binder is preferably a vinyl polymer having in the side chain a carboxyl group and a polymerizable double bond. As the polymer binder is also preferred an unsaturated bond-containing copolymer which is obtained by reacting a carboxyl group contained in the above vinyl copolymer molecule with for example, a compound having a (meth)acryloyl group and an epoxy group. Examples of the compound having a (meth)acryloyl group and an epoxy group in the molecule include glycidyl acrylate, glycidyl methacrylate and an epoxy group-containing unsaturated compound disclosed in Japanese Patent O.P.I. Publication No. 11-27196. Further, an unsaturated bond-containing copolymer which is obtained by reacting a hydroxyl group contained in the above vinyl copolymer molecule with for example, a compound having a (meth)acryloyl group and an isocyanate group. Examples of the compound having a (meth)acryloyl group and an isocyanate group in the molecule include vinyl isocyanate, (meth)acryl isocyanate, 2-(meth)acroyloxyethyl isocyanate, m- or p-isopropenyl-α,α′-dimethylbenzyl isocyanate, and (meth)acryl isocyanate, or 2-(meth)acroyloxyethyl isocyanate is preferred.

Reaction of a carboxyl group existing in the molecule of the vinyl copolymer with a compound having in the molecule a (meth)acryloyl group and an epoxy group can be carried out according to a well-known method. For example, the reaction is carried out at a temperature of 20 to 100° C., and preferably 40 to 80° C., and more preferably at a boiling point of solvent used (while refluxing), for 2 to 10 hours and preferably 3 to 6 hours. As the solvent used in the reaction, there are solvents used in the polymerization to obtain the vinyl copolymer above. After polymerization, the solvent in the polymerization can be used without being removed from the polymerization solution as a reaction solvent used for reaction in which an aliphatic epoxy group-containing unsaturated compound is incorporated into the vinyl copolymer. The reaction can be carried out in the presence of a catalyst or a polymerization inhibitor. As the catalyst, there are amines or ammonium chlorides. Examples of the amines include triethylamine, tributylamine, dimethylaminoethanol, diethylaminoethanol, methylamine, ethylamine, n-propylamine, i-propylamine, 3-methoxypropylamine, butylamine, allylamine, hexylamine, 2-ethylhexylamine, and benzylamine. Examples of the ammonium chlorides include triethylbenzylammonium chloride. The amount used of the catalyst is ordinarily from 0.01 to 20.0% by weight based on the weight of an aliphatic epoxy group-containing unsaturated compound used. Examples of the polymerization inhibitor include hydroquinone, hydroquinone monometyl ether, 2,5-di-t-butylhydroquinone, 2,6-di-t-butylhydroquinone, 2-methylhydroquinone, and 2-t-butylhydroquinone. The amount used of the polymerization inhibitor is ordinarily from 0.01 to 5.0% by weight based on the weight of aliphatic epoxy group-containing unsaturated compound used. The reaction process is controlled by measurement of acid value of the reaction mixture and the reaction is terminated at the time when the intended acid value is attained.

Reaction of a hydroxyl group existing in the molecule of the vinyl copolymer with a compound having in the molecule a (meth)acryloyl group and an isocyanate group can be carried out according to a known method. For example, the reaction is carried out at a temperature of 20 to 100° C., and preferably 40 to 80° C., and more preferably at a boiling point of solvent used (while refluxing), for 2 to 10 hours and preferably 3 to 6 hours. As the solvent used in the reaction, there are solvents used in the polymerization to obtain the vinyl copolymer above. After polymerization, the solvent in the polymerization can be used without being removed from the polymerization solution as a reaction solvent used for reaction in which an isocyanate group-containing unsaturated compound is incorporated into the vinyl copolymer. The reaction can be carried out in the presence of a catalyst or a polymerization inhibitor. As the catalyst, tin compounds or amines are preferably used. Examples of thereof include dibutyltin laurate, and triethylamine. The amount used of the catalyst is preferably from 0.01 to 20.0% by weight based on the weight of a double bond-containing compound used. Examples of the polymerization inhibitor include hydroquinone, hydroquinone monometyl ether, 2,5-di-t-butylhydroquinone, 2,6-di-t-butylhydroquinone, 2-methylhydroquinone, and 2-t-butylhydroquinone. The amount used of the polymerization inhibitor is ordinarily from 0.01 to 5.0% by weight based on the weight of isocyanate group-containing unsaturated compound used. The reaction process is controlled by measurement of infrared absorption spectra (IR) of the reaction mixture and the reaction is terminated at the time when the isocyanate absorption disappears.

The content of the vinyl polymer having in the side chain a carboxyl group and a polymerizable double bond is preferably from 50 to 100% by weight, and more preferably 100% by weight, based on the total weight of the polymer binder used.

The alkali-soluble polymeric binder content of the light sensitive layer is preferably from 10 to 90% by weight, more preferably from 15 to 70% by weight, and still more preferably from 20 to 50% by weight, in view of sensitivity.

In the invention, the thickness of the light sensitive layer is preferably from 0.5 to 4.0 g/m², and more preferably from 1.0 to 3.0 g/m².

(Aluminum Support)

As an aluminum material for the aluminum support in the invention, pure aluminum or an aluminum alloy is used. As the aluminum alloy, there can be used various ones including an alloy of aluminum and a metal such as silicon, copper, manganese, magnesium, chromium, zinc, lead, bismuth, nickel, titanium, sodium or iron. The aluminum support in the invention is ordinarily surface-roughened for water retention.

The aluminum support in the invention is preferably an aluminum support obtained by surface-roughening an aluminum plate according to a procedure described below. The aluminum plate is subjected to degreasing treatment for removing rolling oil prior to surface roughening (graining). The degreasing treatments include degreasing treatment employing solvents such as trichlene and thinner, and an emulsion degreasing treatment employing an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution such as caustic soda is used for the degreasing treatment, the resulting plate is preferably subjected to desmut treatment in an aqueous solution of an acid such as phosphoric acid, nitric acid, sulfuric acid, chromic acid or a mixture thereof, in order to remove smuts produced on the surface thereof.

The surface roughening methods include a mechanical surface roughening method and an electrolytic surface roughening method electrolytically etching the support surface. Though there is no restriction for the mechanical surface roughening method, a brushing roughening method and a honing roughening method are preferable.

Though there is no restriction for the electrolytic surface roughening method, a method, in which the aluminum plate is electrolytically surface roughened in an acidic electrolytic solution, is preferred. After the plate has been electrolytically surface roughened, it is preferably dipped in an acid or an aqueous alkali solution in order to remove aluminum dust, etc. produced on the surface. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used. The dissolution amount of aluminum in the aluminum plate surface is preferably 0.5 to 5 g/m². After the aluminum plate has been dipped in the aqueous alkali solution, it is preferably dipped in an acid such as phosphoric acid, nitric acid, sulfuric acid and chromic acid, or in a mixed acid thereof, for neutralization.

The mechanical surface roughening and electrolytic surface roughening may be carried out singly, and the mechanical surface roughening followed by the electrolytic surface roughening may be carried out.

After the surface roughening, anodizing treatment may be carried out. There is no restriction in particular for the method of anodizing treatment used in the invention, and known methods can be used. The anodizing treatment forms an anodization film on the surface of the aluminum plate.

The aluminum plate, which has been subjected to anodizing treatment, is optionally subjected to sealing treatment. For the sealing treatment, it is possible to use known methods using hot water, boiling water, steam, a sodium silicate solution, an aqueous dichromate solution, a nitrite solution and an ammonium acetate solution.

After the above treatment, the resulting aluminum plate is suitably undercoated with a water soluble resin such as polyvinyl phosphonic acid, a polymer or copolymer having a sulfonic acid in the side chain, or polyacrylic acid; a water soluble metal salt such as zinc borate; a yellow dye; an amine salt; and so on, for hydrophilization treatment. The sol-gel treatment support disclosed in Japanese Patent O.P.I. Publication No. 5-304358, which has a functional group capable of causing addition reaction by radicals as a covalent bond, is suitably used.

(Preparation Planographic Printing Plate Material)

The planographic printing plate material of the invention is obtained by coating on the aluminum support a light sensitive layer coating liquid containing a composition constituting the light sensitive layer described above to form a light sensitive layer on the aluminum support. Solvents used for the light sensitive layer coating liquid include an alcohol such as sec-butanol, isobutanol, n-hexanol, or benzyl alcohol; a polyhydric alcohol such as diethylene glycol, triethylene glycol, tetraethylene glycol, or 1,5-pentanediol; an ether such as propylene glycol monobutyl ether, dipropylene glycol monomethyl ether, or tripropylene glycol monomethyl ether; a ketone such as diacetone alcohol, methyl ethyl ketone, cyclohexanone, or methyl cyclohexanone; and an ester such as ethyl lactate, butyl lactate, diethyl oxalate, or methyl benzoate.

The light sensitive layer coating liquid is coated on the support according to a conventional method, and dried to obtain a planographic printing plate material. Examples of the coating method include an air doctor coating method, a blade coating method, a wire bar coating method, a knife coating method, a dip coating method, a reverse roll coating method, a gravure coating method, a cast coating method, a curtain coating method, and an extrusion coating method. The drying temperature of the coated light sensitive layer is preferably from 60 to 160° C., more preferably from 80 to 140° C., and still more preferably from 90 to 120° C.

(Preparation of Planographic Printing Plate)

The planographic printing plate material of the invention is imagewise exposed employing violet laser beams, and developed with a developer described later to prepare a planographic printing plate for printing.

(Imagewise Exposure)

In the invention, imagewise exposure for forming an image is carried out employing violet laser beams.

(Violet Laser Beams)

The violet laser beams used in the invention are preferably laser beams having emission wavelength in wavelength regions of from 350 to 440 nm. As the laser beams having emission wavelength in wavelength regions of from 350 to 440 nm available on the market, there are a combination of a guiding wavelength conversion element and AlGaAs, InGaAs semiconductor (380 to 440 nm), AlGaInN (350 to 440 nm), and XeF (351 nm, pulse: 10 to 250 mJ) as pulse laser. The semiconductor laser is preferably used.

As a laser scanning method by means of a laser beam, there are a method of scanning on an outer surface of a cylinder, a method of scanning on an inner surface of a cylinder and a method of scanning on a plane. In the method of scanning on an outer surface of a cylinder, laser beam exposure is conducted while a drum around which a recording material is wound is rotated, in which main scanning is represented by the rotation of the drum, while sub-scanning is represented by the movement of the laser beam. In the method of scanning on an inner surface of a cylinder, a recording material is fixed on the inner surface of a drum, a laser beam is emitted from the inside, and main scanning is carried out in the circumferential direction by rotating a part of or an entire part of an optical system, while sub-scanning is carried out in the axial direction by moving straight a part of or an entire part of the optical system in parallel with a shaft of the drum. In the method of scanning on a plane, main scanning by means of a laser beam is carried out through a combination of a polygon mirror, a galvano mirror and an Fθ lens, and sub-scanning is carried out by moving a recording medium. The method of scanning on an outer surface of a cylinder and the method of scanning on an inner surface of a cylinder are suitable for high density image recording, since it is easier to increase accuracy of an optical system.

(Alkali Development)

Preheat Treatment

In the invention, the exposed planographic printing plate material can be subjected to heat treatment before or during development. Such a heat treatment can increase adhesion of the light sensitive layer to the substrate and further increase the effect of the invention.

Regarding preheat treatment, there is, for example, a developing machine in which a preheating roller for preheating an exposed planographic printing plate material to a predetermined temperature is arranged upstream a development section where the preheat treatment is carried out before development. The preheating roller is a roller comprised of a pair of rollers, at least one of the pair of the rollers having a heating means within the roller. The roller having a heating means in it is a pipe of a metal with high thermal conductivity such as aluminum or iron, the pipe having a nichrome wire as a heating element. The outside surface of the pipe may be covered with a sheet of a plastic such as polyethylene, polystyrene or Teflon. Details of such a preheating roller can refer to Japanese Patent O.P.I. Publication No. 64-80962.

In the invention, it is preferred that the preheating is carried out at 70 to 180° C. for 3 to 120 seconds.

Developer

The light sensitive layer of the planographic printing plate material of the invention after imagewise exposure is cured at exposed portions, and the resulting material is developed with an alkali developer, whereby the light sensitive layer at unexposed portions are removed to form an image. As the alkali developer, a conventional alkali aqueous solution is used. For example, there is an alkali developer containing an inorganic alkali agent such as sodium silicate, potassium silicate, ammonium silicate, sodium secondary phosphate, potassium secondary phosphate, ammonium secondary phosphate; sodium hydrogen carbonate, potassium hydrogen carbonate, ammonium hydrogen carbonate; sodium carbonate, potassium carbonate, ammonium carbonate; sodium borate, potassium borate, lithium borate; sodium hydroxide, potassium hydroxide, and ammonium hydroxide.

The alkali developer can contain organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine.

These alkali agents can be used singly or as a mixture of two or more thereof. The alkali developer can contain an anionic surfactant, an amphoteric surfactant, or an organic solvent such as alcohol.

In the invention the preferred alkali developer used in the preparation of a printing plate is an aqueous solution having a silicate content of from 1.0 to 4.0% by weight in terms of SiO₂ concentration, and having a pH of from 8.5 to 12.5. The aqueous solution can contain another additive. It is preferred that the aqueous solution further contains a surfactant in an amount of from 0.1 to 5.0% by weight.

### EXAMPLES

Next, the present invention will be explained below employing examples, but the present invention is not limited thereto. In the examples, “parts” represents “parts by weight”, unless otherwise specified.

### Example 1

Preparation of Planographic Printing Plate Material Sample

(Preparation of Support)

A 0.30 mm thick aluminum plate (material 1050, refining H16) was degreased at 65° C. for one minute in a 5% sodium hydroxide solution, washed with water, immersed at 25° C. for one minute in a 10% sulfuric acid solution to neutralize, and then washed with water. The resulting aluminum plate was electrolytically etched using an alternating current at 25° C. for 20 seconds at a current density of 50 A/dm² and at a frequency of 50 Hz in an aqueous 11 g/liter hydrochloric acid solution, washed with water, desmutted at 50° C. for 10 seconds in a 1% sodium hydroxide solution, washed with water, neutralized at 50° C. for 30 seconds in a 30% sulfuric acid solution, and washed with water. The desmutted aluminum plate was anodized at 25° C. for 30 seconds at a current density of 30 A/dm² and at a voltage of 25 V in a 30% sulfuric acid solution, and washed with water. The resulting anodized aluminum plate was immersed in a 0.44% polyvinyl phosphonic acid aqueous solution at 75° C. for 30 seconds, washed with pure water, and dried blowing 25° C. cool air. Thus, support for planographic printing plate material sample was obtained. The center-line average surface roughness (Ra) of the support was 0.50 μm.

The following light sensitive layer coating solution was coated on the resulting support, and dried at 90° C. for 1 minute to give a light sensitive layer with a dry thickness of 2.0 g/m². Thus, planographic printing plate material samples 1 through 8 were obtained.

(Light sensitive layer coating solution)

| | |
|---|---|
| Polymeric binder B-1 (*1) | 30 parts |
| Cationically polymerizable compound | 40 parts |
| 1,6-Hexanediol diglycidyl ether | |
| Cationically polymerizable compound | 20 parts |
| Oxetane compound 4 | |
| Acid generating agent | 6 parts |
| (as shown in Table 1) | |
| Dye (as shown in Table 1) | 3 parts |
| Crystal violet | 0.5 parts |
| Silicon-containing surfactant | 0.5 parts |
| (Edaplan LA411) | |
| PGM (propylene glycol monometyl ether) | 700 parts |
| MEK (Methyl ethyl ketone) | 200 parts |

(*1) Polymeric binder B-1 was synthesized according to the following procedures.

Methyl methacrylate of 125 parts, 12 parts of ethyl methacrylate, 63 parts of methacrylic acid, 240 parts of cyclohexanone, 160 parts of isopropyl alcohol, and 5 parts of α,α′-azobisisobutylonitrile were placed in a three neck flask under nitrogen atmosphere. The resulting mixture was reacted under nitrogen atmosphere for 6 hours at 80° C. in an oil bath. After that, the reaction mixture was added with 4 parts of triethylbenzylammonium chloride and 52 parts of glycidyl methacrylate, and reacted at 25° C. for 3 hours. Thus, Polymeric binder B-1 was obtained. Polymeric binder B-1 had a weight average molecular weight of 55,000 in terms of polystyrene, measured according to GPC.

Each of the resulting planographic printing plate material samples was cut into two. One of the two was stored at 23° C. and at 55% RH for three days, and the other was stored at 40° C. and at 80% RH for three days.

The resulting samples were imagewise exposed and developed according to the following procedures.

Imagewise Exposure

Samples 2 through 8 were imagewise exposed employing a 200 mW laser exposure equipment with 405 nm violet laser, while sample 1 was imagewise exposed employing a 500 mW laser exposure equipment with 830 nm infrared semiconductor laser. Herein, the image pattern used for imagewise exposure comprised a solid image and a dot image with a dot area of from 1 to 99%.

The exposed samples were developed at 30° C. for 20 seconds with a developer having the following composition.

Developer

| | |
|---|---|
| Potassium silicate A | 116 parts |
| (containing 25.5-27.5% by weight of SiO₂ and 12.5-14.5% | |
| by weight of K₂O) | |
| Aqueous 45% potassium hydroxide solution | 27 parts |
| Water | 715 parts |

The light sensitive layer at unexposed portions of the samples was dissolved and removed by the above development to obtain a clear image.

Dot reproducibility at highlight portions was determined. The dot image obtained above was measured through a ccDot meter produced by Centerflux Co., Ltd., and the minimum dot area (%) in which measured value of dot area was 2% was determined. The smaller the minimum dot area is, the better the dot reproducibility.

The results are shown in Table 1.

TABLE 1

| | | | | | Dot | | |
|---|---|---|---|---|---|---|---|
| | Acid generating agent | | | | reproducibility | | |
| | used | | | | at highlight | | |
| Sample | | | Weight | Dye | 50° C., | 40° C., | Re- |
| No. | Kind | Kind | ratio | Kind | 55% RH | 80% RH | marks |
| 1 | B^{b)} | None | | A-2 | 4 | 15 | Comp. |
| 2 | B | None | | D12 | 3 | 5 | Inv. |
| 3 | A^{a)} | None | | D12 | 2 | 3 | |
| 4 | None | BR43 | | D12 | 2 | 3 | |
| 5 | A | BR22 | 60/40 | D12 | 2 | 2 | |
| 6 | A | BR22 | 60/40 | C-3 | 2 | 2 | |
| 7 | A | BR22 | 60/40 | E56 | 2 | 2 | |
| 8 | A | BR22 | 60/40 | 5-1 | 2 | 2 | |

Comp.: Comparative, Inv.: Inventive
^{a)}A: η-cumene-(η-cyclopentadienyl)iron hexafluorophosphate
^{b)}B: Diphenyliodonium chloride

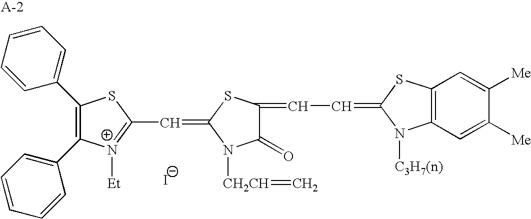

As is apparent from Table 1, inventive planographic printing plate material samples provide excellent storage stability at high humidity, and excellent reproducibility at highlight portions after stored at high humidity.

What is claimed is:

1. A planographic printing plate material comprising an aluminum support and provided thereon, a light sensitive layer containing an acid-generating agent composition generating an acid on violet laser beam exposure, a cationically polymerizable monomer which polymerizes by action of an acid, and an alkali-soluble polymeric binder, wherein the light sensitive layer is an outermost layer.

2. The planographic printing plate material of claim 1, wherein the acid-generating agent composition is comprised of the acid-generating agent and a dye having absorption maximum in the wavelength regions of from 350 to 440 nm.

3. The planographic printing plate material of claim 2, wherein the acid-generating agent is an iron-arene complex.

4. The planographic printing plate material of claim 2, wherein the acid-generating agent is a halogen-containing compound represented by the following formula (1),
R¹—C(Y)₂—(C═O)—R² Formula (1)
wherein R¹ represents a hydrogen atom, a halogen atom, an alkyl group, an aryl group, an acyl group, an alkylsulfonyl group, an arylsulfonyl group, or a cyano group; R² represents a monovalent substituent, provided that R¹ and R² may combine with each other to form a ring; and Y represents a halogen atom.

5. The planographic printing plate material of claim 4, wherein the halogen-containing compound represented by formula (1) is a halogen-containing compound represented by the following formula (1′),
C(Y)₃—(C═O)—X—R³ Formula (1′)
wherein R³ represents a monovalent substituent, X represents —O— or —NR⁴— in which R⁴ represents a hydrogen atom or an alkyl group, provided that when X represents —NR⁴—, R³ and R⁴ may combine with each other to form a ring; and Y represents a halogen atom.

6. The planographic printing plate material of claim 2, wherein the dye is represented by the following formula (2), 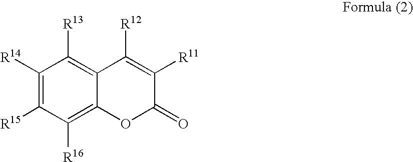
wherein R¹¹, R₁₂, R¹³, R¹⁴, R¹⁵ and R¹⁶ independently represent a hydrogen atom, an alkyl group, a cycloalkyl group, an alkenyl group, an alkinyl group, an aryl group, a heteroaryl group, a heterocyclic group, an alkoxy group, a cycloalkoxy group, an aryloxy group, an alkylthio group, a cycloalkylthio group, an arylthio group, an alkoxycarbonyl group, an aryloxycarbonyl group, a sulfamoyl group, an acyl group, an acyloxy group, an amido group, a carbamoyl group, a ureido group, a sulfinyl group, an alkylsulfonyl group, an amino group, a halogen atom, a cyano group, a nitro group or a hydroxyl group, provided that any adjacent two of R¹¹, R¹², R¹³, R¹⁴, R¹⁵ and R¹⁶ may combine with each other to form a ring.

7. The planographic printing plate material of claim 2, wherein the dye is represented by the following formula (3), 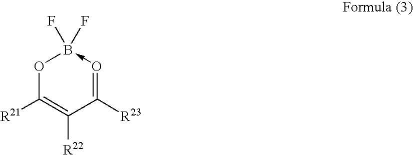
wherein R²¹, R²² and R²³ independently represent a hydrogen atom or a substituent, provided that R²¹ and R²² may combine with each other to form a ring or R²² and R²³ may combine with each other to form a ring.

8. The planographic printing plate material of claim 2, wherein the dye is represented by the following formula (4), 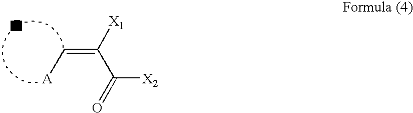
wherein A represents a sulfur atom or —NR₁— in which R₁ represents a substituted or unsubstituted alkyl group or a substituted or unsubstituted aryl group; Z represents a non-metallic atomic group necessary to form a basic nucleus together with A; and X₁ and X₂ independently represent a monovalent substituent, provided that X₁ and X₂ may combine with each other to form an acidic nucleus.

9. The planographic printing plate material of claim 2, wherein the dye is represented by the following formula (5), 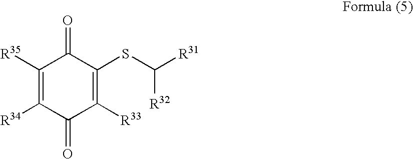
wherein R³¹ represents an alkyl group, an aryl group, an alkenyl group, a cycloalkyl group, an aralkyl group or a heterocyclic group; R³² represents a hydrogen atom, an alkyl group, an aryl group, an alkenyl group, a cycloalkyl group, an aralkyl group or a heterocyclic group, provided that R³¹ and R³² may combine with each other to form a ring; and R³³, R³⁴ and R³⁵ independently represent a hydrogen atom, an alkyl group, an alkoxy group, an aryloxy group, an alkylthio group, an arylthio group, a dialkylamino group or a diarylamino group.

10. The planographic printing plate material of claim 1, wherein the light sensitive layer contains, as the cationically polymerizable monomer, an epoxy compound, a vinyl ether compound or an oxetane compound.

11. The planographic printing plate material of claim 1, wherein the light sensitive layer contains, as the cationically polymerizable monomer, an oxetane compound and at least one of an epoxy compound and a vinyl ether compound.

12. The planographic printing plate material of claim 2, wherein the light sensitive layer contains 0.1 to 20% by weight of the dye, 20 to 80% by weight of the cationically polymerizable monomer and 15 to 70% by weight of the alkali-soluble polymeric binder, each based on the total weight of light sensitive layer, and 0.1 to 20% by weight of the acid-generating agent based on the weight content of the cationically polymerizable monomer.

13. An image formation method comprising the steps of:
(a) imagewise exposing the light sensitive layer of the planographic printing plate material of claim 1 above, employing violet laser beam; and
(b) removing the light sensitive layer at unexposed portions employing an alkaline developer.
